(19) United States
(12) Patent Application Publication
(10) Pub. No.: US 2012/0177859 A1
(43) Pub. Date: Jul. 12, 2012

(54) BIODEGRADABLE, PRINTABLE OR FUNCTIONAL FILM

(75) Inventors: Thierry Gavel, Brussels (BE); Wayne Middleton, Wigton (GB); Veli Nasib, Espoo (FI); Gianpaolo Faletti, Brussels (BE); Jonathan Hewitt, Wigton (GB); Andy Sweetman, Wigton (GB)

(73) Assignee: INNOVIA FILMS LIMITED, Wigton (GB)

(21) Appl. No.: 13/334,293

(22) Filed: Dec. 22, 2011

Related U.S. Application Data
(63) Continuation-in-part of application No. 12/222,498, filed on Aug. 11, 2008, now Pat. No. 8,173,234.
Application No. 12/222,498 is a division of application No. 10/471,694, filed on May 24, 2004, now Pat. No. 7,687,125.
Application No. 10/471,694 is a continuation-in-part of application No. 13/205,128, filed on Aug. 8, 2011.
Application No. 13/205,128 is a continuation-in-part of application No. 12/677,436, filed on May 19, 2010.
Application No. 12/677,436 is a continuation-in-part of application No. 12/673,556, filed on Jun. 28, 2010, now Pat. No. 8,182,889.

(30) Foreign Application Priority Data
Mar. 15, 2001 (GB) 0106410.4
Aug. 23, 2007 (GB) 0716456.9
Sep. 14, 2007 (GB) 0717974.0

(51) Int. Cl. B32B 33/00; B32B 29/00; B32B 5/02; B32B 27/32; B32B 27/06; B32B 27/08; B32B 27/36; C09J 7/04; C09J 7/02; B32B 15/08; B32B 3/10; B32B 9/04; B32B 27/34

(52) U.S. Cl. 428/41.8; 428/411.1; 428/537.5; 442/59; 428/523; 428/532; 428/474.4; 428/480; 428/221; 428/354; 428/457; 428/195.1

(57) ABSTRACT

A biodegradable multi-layer film is disclosed. The biodegradable film comprises a biodegradble core layer and a biodegradable, printable or otherwise functional layer comprising PLA or a PLA derivative. The printable or otherwise functional layer may be coated with a biodegradable, sealable coating layer.

This application is a continuation-in-part application of U.S. patent application Ser. No. 12/222,498, filed on Aug. 11, 2008, which is a divisional application of U.S. patent application Ser. No. 10/471,694, filed on May 24, 2004, now U.S. Pat. No. 7,687,125, which is a national entry of PCT/EP02/02726, filed on Mar. 13, 2002, which claims priority of Great Britain Application No. GB0106410.4, filed on Mar. 15, 2001. This application is also a continuation-in-part of U.S. patent application Ser. No. 13/205,128, filed on Aug. 8, 2011, which is a continuation-in-part application of U.S. patent application Ser. No. 12/222,498, described above. This application is also a continuation-in-part application of U.S. patent application Ser. No. 12/677,436, filed on May 19, 2010, which is a national entry of PCT/GB08/50778, filed on Sep. 3, 2008, which claims priority of Great Britain Application No. GB0717974.0, filed on Sep. 14, 2007. This application is also a continuation-in-part application of U.S. patent application Ser. No. 12/673,556, filed on Jun. 28, 2010, which is a national entry of PCT/GB08/50676, filed on Aug. 7, 2008, which claims priority of Great Britain Application No. GB0716456.9, filed on Aug. 23, 2007. The entirety of all of the aforementioned applications is incorporated herein by reference.

### FIELD

The present application relates generally to printable or otherwise functional films and, in particular, to printable or otherwise functional films with a biodegradable core layer and a biodegradable, printable or otherwise functional skin layer.

### BACKGROUND

Printable films have been widely used as labels and packaging materials. In recent years, the increasing environmental consciousness has been directing attention to application of biodegradable resins to the film industry. After disposal, films made of biodegradable resins can be broken down by bacteria and return to soil even buried in a landfill or left to stand under natural environmental conditions. Under these circumstances, there exists a need for printable films that are biodegradable while maintaining the desired film properties such as ink adhesive properties, sheet running properties, anti-blocking properties and antistatic properties and the like. There also exists a need for films that are biodegradable while maintaining other functionality such as barrier properties (moisture and/or gas/air and/or UV), UV stability or excellent visual characteristics.

### SUMMARY

One aspect of the present invention relates to a biodegradable, printable or otherwise functional, multi-layer film comprising a biodegradable core layer and a biodegradable, printable or otherwise functional skin layer of a different material from that of the biodegradable core layer on at least one side of the film; at least one of the biodegradable core layer and the biodegradable skin layer comprising a biopolymer.

By “otherwise functional” is preferably meant that the film exhibits at least one barrier property—either to moisture, or to air or gases generally, or to light (UV or otherwise), and/or that the film has excellent visual characteristics.

The biodegradable core layer and the biodegradable skin layer may, independently be selected from biodegradable polymers, paper, post consumer reclaim (PCR) fibres, and biodegradable polyethylene, provided that the material of the biodegradable core layer is different from that of the skin layer.

The biodegradable polymers may be obtained or obtainable from a biological source, such as a plant or microbial source. In particular the biodegradable polymers may be selected from carbohydrates, polysaccharides, gums, proteins, colloids, polyorganic acids and polyesters, effective mixtures thereof or effective modified derivatives thereof.

The polysaccharides may be selected from cellulose, starch, glycogen, hemi-cellulose, chitin, fructan, inulin, lignin or pectic substances.

The proteins may be selected from cereal, vegetable or animal proteins, for example from gluten, whey protein or gelatin.

The polyorganic acids and esters may be selected from polylactic acid (PLA), polygalactic acid (PGA), polyhydroxy-alkanoate (PHA), polyhydroxy butyrate (PHB), polycaprolactone) (PCL) and poly-methyl 4-hydroxybenzoate (MHB) and polyhydroxy-benzonate (PHB).

The biopolymer may be selected from carbohydrates, polysaccharides, gums, proteins, colloids, polyorganic acids and polyesters, effective mixtures thereof or effective modified derivatives thereof.

The polysaccharides of the biopolymer may be selected from cellulose, starch, glycogen, hemi-cellulose, chitin, fructan, inulin, lignin or pectic substances.

The polyorganic acids and esters are of the biopolymer may be selected from polylactic acid (PLA), polygalactic acid (PGA), polyhydroxy-alkanoate (PHA), polyhydroxy butyrate (PHB), polycaprolactone) (PCL) and poly-methyl 4-hydroxybenzoate (MHB) and polyhydroxy-benzonate (PHB).

At least one of the core layer, the skin layer, or a further layer of the film may be a cellulosic layer.

At least one of the core layer, the skin layer, or a further layer of the film may be paper.

At least one of the core layer, the skin layer, or a further layer of the film may be a biodegradable polyester.

The core layer of the multi-layer film may have one or more further layers and/or coatings on both its sides (of which one such layer is the skin layer) and may therefore be a contained layer. Alternatively, the core layer may have one or more further layers and/or coatings (of which one such layer is the skin layer) on only one of its sides and may therefore be an exposed layer.

The skin layer of the multi-layer film may have one or more further layers and/or coatings on both its sides (of which one such layer is the core layer) and may therefore be a contained layer. Alternatively, the skin layer may have one or more further layers and/or coatings (of which one such layer is the core) on only one of its sides and may therefore be an exposed layer.

There may be one or more further layers interposed between the core layer and the skin layer and/or on the skin layer away from the core layer and/or on the core layer away from the skin layer.

The core layer is not necessarily the thickest layer in the film, although it may be.

The skin layer is not necessarily the thinnest layer in the film, although it may be.

The core layer is not necessarily thicker than the skin layer, although it may be.

One aspect of the present invention relates to a biodegradable multi-layer film. In a preferred embodiment the film comprises a cellulose core layer, and a first biodegradable, printable or otherwise functional layer comprising a biodegradable polyester such as PLA or a PLA derivative.

In a related embodiment, the cellulose core layer comprises regenerated cellulose.

In another embodiment, the multi-layer film further comprises a primer layer between the cellulose core layer and the printable or otherwise functional layer.

In another embodiment, the multi-layer film further comprises a biodegradable, sealable coating layer.

In a related embodiment, the biodegradable, sealable coating layer comprise a coploymer of lactic acid and caprolactone.

In another related embodiment, the sealable layer covers the printable or otherwise functional layer.

In another related embodiment, the printable or otherwise functional layer and the sealable layer are located on the opposite side of the core layer.

In another embodiment, the multi-layer film further comprises a second biodegradable printable or otherwise functional layer, wherein the first and second biodegradable printable or otherwise functional layers are located on the opposite sides of the core layer.

In another embodiment, the multi-layer film further comprises a pressure sensitive adhesive layer, wherein the pressure sensitive adhesive layer and the biodegradable printable or otherwise functional layer are located on the opposite sides of said core layer.

In a related embodiment, the pressure sensitive adhesive layer is covered with a release layer.

In another embodiment, the multi-layer film further comprises a barrier layer.

In a related embodiment, the barrier layer is a metal layer.

In another embodiment the multi-layer film further comprises a biodegradable ink layer.

Another aspect of the invention relates to a biodegradable multi-layer film that comprises a biodegradable core layer and a biodegradable, printable or otherwise functional layer on each side of the biodegradable core layer, wherein each of the biodegradable, printable or otherwise functional layer comprises PLA or a PLA derivative and is in direct contact with the biodegradable core layer.

In one embodiment, the biodegradable core layer comprises cellulose.

In another embodiment, the multi-layer film further comprises a barrier layer.

In another embodiment, the multi-layer film further comprises a biodegradable ink layer.

Another aspect of the invention relates to a method for producing a biodegradable multi-layer film. The method comprises covering a biodegradable core layer with a biodegradable printable or otherwise functional layer by extrusion coating.

The biodegradable printable or otherwise functional layer may comprise PLA or a PLA derivative; and the process may include printing on the printable or otherwise functional layer with a biodegradable ink to form an ink layer.

In one embodiment, the method further comprises coating the ink layer with a sealable coating layer comprising a copolymer of lactic acid and caprolactone.

In another embodiment, the cellulose core layer is a metalized cellulose layer.

### BRIEF DESCRIPTION OF DRAWINGS

For the purposes of this disclosure, unless otherwise indicated, identical reference numerals used in different figures refer to the same component.

FIGS. 1A and 1B are diagrams showing embodiments of a multi-layer, biodegradable film with a biodegradable core layer coated with a printable or otherwise functional, biodegradable coating layer on one side (FIG. 1A) or both sides (FIG. 1B).

FIGS. 2A and 2B are diagrams showing embodiments of a multi-layer, biodegradable film with a biodegradable core layer, a printable or otherwise functional, biodegradable coating layer and a biodegradable ink layer (FIG. 2A) and a multi-layer, biodegradable film with a biodegradable core layer, a printable or otherwise functional, biodegradable coating layer, a biodegradable ink layer and a biodegradable, sealable coating layer (FIG. 2B).

FIG. 3 is a diagram showing an embodiment of a multi-layer, biodegradable film with a biodegradable core layer, a printable or otherwise functional, biodegradable coating layer, a biodegradable ink layer, a biodegradable, sealable coating layer and a barrier layer.

FIG. 4 is a diagram showing force-extension curves for a cellulose film, a PLA film and a BOPP film.

FIG. 5 is a diagram showing bending stiffness of a cellulose film, PLA film, BOPP film and an 85 micron thick polyethylene film (PE).

FIG. 6 is a diagram showing dynamic mechanical thermal analysis (DMTA) of a cellulose film, a PLA film and a BOPP film.

FIG. 7 is a diagram showing tear initiation resistance of a cellulose film, a PLA film and a BOPP film in both machine direction (MD) and transverse direction (TD).

FIG. 8 is a diagram showing film dimension change as a function of temperature, when heating at 2° C./min.

FIG. 9 is a diagram showing film dimension change as a function of temperature, starting at 0° C. and room temperature.

### DETAILED DESCRIPTION

The following detailed description is presented to enable any person skilled in the art to make and use the invention. For purposes of explanation, specific nomenclature is set forth to provide a thorough understanding of the present application. However, it will be apparent to one skilled in the art that these specific details are not required to practice the invention. Description of specific embodiments and applications is provided only as representative examples. This description is an exemplification of the principles of the invention and is not intended to limit the invention to the particular embodiments illustrated.

This description is intended to be read in connection with the accompanying drawings, which are to be considered part of the entire written description of this invention. The drawings are not necessarily to scale and certain features of the invention may be shown exaggerated in scale or in somewhat schematic form in the interest of clarity. In the description, relative terms such as “front,” “back,” “up,” “down,” “top” and “bottom,” as well as derivatives thereof, should be construed to refer to the orientation as then described or as shown in the drawing under discussion. These relative terms are for convenience of description and normally are not intended to require a particular orientation.

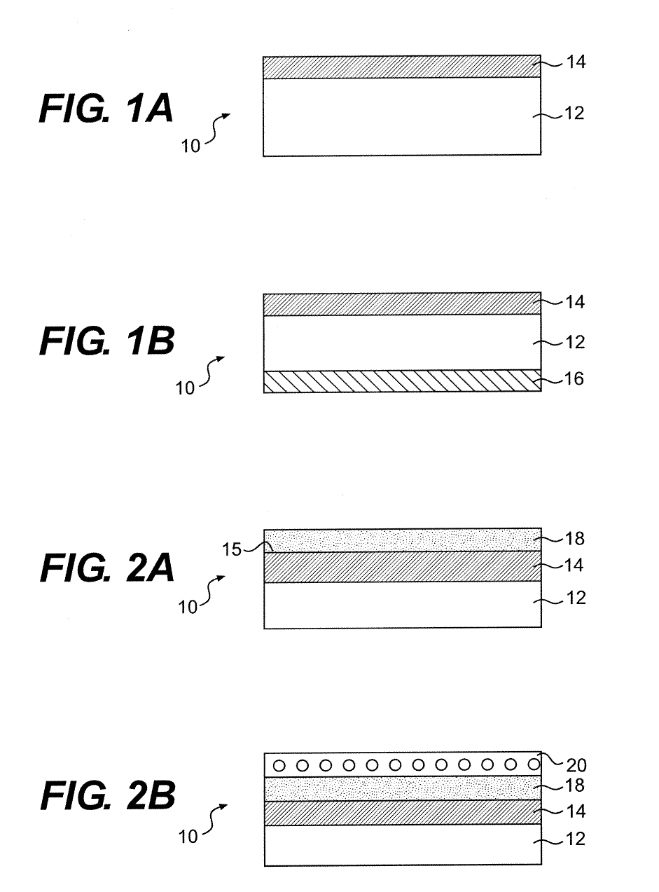

One aspect of the present invention relates to a biodegradable, printable or otherwise functional film that contains a biodegradable core layer and a biodegradable, printable or otherwise functional skin layer on at least one side of the film. FIG. 1A shows an embodiment of the multi-layer film of the present invention. In this embodiment, the film 10 comprises a biodegradable core layer 12 coated with a biodegradable, printable or otherwise functional layer 14 on one side. In the embodiment shown in FIG. 1B, the biodegradable core layer 12 is coated on both sides with biodegradable, printable or otherwise functional layers 14 and 16. In this embodiment, the biodegradable, printable or otherwise functional layers 14 and 16 may comprise the same material or different materials. In one embodiment, the skin layer exhibits at least one barrier property—either to moisture, or to air or gases generally, or to light (UV or otherwise), and/or that the skin layer has excellent visual characteristics.

FIG. 2A shows another embodiment of the multi-layer film of the present invention. In this embodiment, the film 10 comprises a biodegradable core layer 12, a biodegradable, printable or otherwise functional layer 14, and a biodegradable ink layer 18. The biodegradable ink layer 18 may be a continuous layer that completely covers the top surface 15 of the biodegradable, printable or otherwise functional layer 14, or a discontinuous layer that partially cover the top surface 15 of the printable or otherwise functional layer 14. In the embodiment shown in FIG. 2B, the biodegradable ink layer 18 is further coated with a sealable coating layer 20.

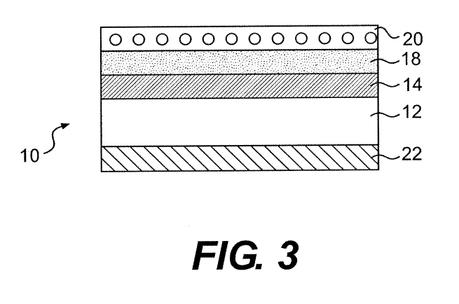

FIG. 3 shows another embodiment of the multi-layer film of the present invention. In this embodiment, the film 10 comprises a biodegradable core layer 12, a biodegradable, printable or otherwise functional layer 14, a biodegradable ink layer 18, a sealable coating layer 20 on top of the biodegradable ink layer 18 and a barrier layer 22 on the other side of the biodegradable core layer 12.

### Biodegradable Core Layer

The biodegradable layer may be made from biodegradable biopolymers, paper, post consumer reclaim (PCR) fibers, and biodegradable polyethylene. Biopolymers are polymers that are obtained and/or obtainable from a biological (preferably plant and/or microbial) source and may comprise those organic polymers which comprise substantially carbon, oxygen and hydrogen. Biodegradable biopolymers may be selected from carbohydrates; polysaccharides (such as cellulose, starch, glycogen, hemi-cellulose, chitin, fructan inulin; lignin and/or pectic substances); gums; proteins, optionally cereal, vegetable and/or animal proteins (such as gluten, whey protein, and/or gelatin); colloids (such as hydro-colloids, for example natural hydrocolloids, e.g. gums); other polyorganic acids and polyesters (such as polylactic acid (PLA), polygalactic acid (PGA), polyhydroxy-alkanoate (PHA), polyhydroxy butyrate (PHB), polycaprolactone) (PCL) and poly-methyl 4-hydroxybenzoate (MHB) and polyhydroxy-benzonate (PHB)), effective mixtures thereof; and/or effective modified derivatives thereof.

Cellulose comprises a long unbranched chain of glucose units. The term “cellulose,” as used herein, includes cellulose and cellulose derivatives such as cellulose esters and cellulose ethers.

Starch may comprise native and/or modified starch obtained and/or obtainable from one or more plant(s); may be a starch, starch-ether, starch-ester and/or oxidised starch obtained and/or obtainable from one or more root(s), tuber(s) and/or cereal(s) such as those obtained and/or obtainable from potato, waxy maize, tapioca and/or rice.

Gluten may comprise a mixture of two proteins, gliadin and glutenin whose amino acid composition may vary although glutamic acid and proline usually predominate.

Gums are natural hydro-colloids which may be obtained from plants and are typically insoluble in organic solvents but form gelatinous or sticky solutions with water. Gum resins are mixtures of gums and natural resins.

As used herein the term carbohydrate will be understood to comprise those compounds of formula Cₓ(H₂O)_{y} which may be optionally substituted. Carbohydrates may be divided into saccharides (also referred to herein as sugars) which typically may be of low molecular weight and/or sweet taste and/or polysaccharides which typically may be of high molecular weight and/or high complexity.

Polysaccharides comprise any carbohydrates comprising one or more monosaccharide (simple sugar) units. Homopolysaccharides comprise only one type of monosaccharide and heteropolysaccharides comprise two or more different types of sugar. Long chain polysaccharides may have molecular weights of up to several million daltons and are often highly branched, examples of these polysaccharides comprise starch, glycogen and cellulose.

Polysaccharides also include the more simple disaccharide sugars, trisaccharide sugars and/or dextrins (e.g. maltodextrin and/or cyclodextrin).

Polysaccharides may comprise a polymer of at least twenty or more monosaccharide units and more preferably have a molecular weight (M) of above about 5000 daltons. Less complex polysaccharides comprise disaccharide sugars, trisaccharide sugars, maltodextrins and/or cyclodextrins. Complex polysaccharides which may be used as biopolymers to form or comprise films of the present invention comprise one or more of the following: Starch (which occurs widely in plants) may comprise various proportions of two polymers derived from glucose:amylose (comprising linear chains comprising from about 100 to about 1000 linked glucose molecules) and amylopectin comprising highly branched chains of glucose molecules).

Glycogen (also known as animal starch) comprises a highly branched polymer of glucose which can occur in animal tissues.

Chitin comprises chains of N-acetyl-D-glucosamine (a derivative of glucose) and is structurally very similar to cellulose.

Fructans comprise polysaccharides derived from fructose which may be stored in certain plants.

Inulin comprises a polysaccharide made from fructose which may be stored in the roots or tubers of many plants.

Lignin comprises a complex organic polymer that may be deposited within the cellulose of plant cell walls to provide rigidity.

Pectic substances such as pectin comprise polysaccharides made up primarily of sugar acids which may be important constituents of plant cell walls. Normally they exist in an insoluble form, but may change into a soluble form (e.g. during ripening of a plant).

Polylactic and/or polygalactic polymers and the like comprise those polymeric chains and/or cross-linked polymeric networks which are obtained from, obtainable from and/or comprise: polylactic acid; polygalactic acid and/or similar polymers and which may be made synthetically and/or sourced naturally.

Other types of polysaccharide derivatives one or more of which may also be used to form (in whole or in part) films of the present invention may comprise any effective derivative of any suitable polysaccharide (such as those described herein) for example those derivatives selected from amino derivatives, ester derivatives (such as phosphate esters) ether derivatives; and/or oxidized derivatives (e.g. acids).

In certain embodiments, the biodegradable core layer is a cellulose layer. In certain embodiments, the biodegradable core layer comprises regenerated cellulose. In other embodiments, the biodegradable core layer is a cellophane layer. In other embodiments, the biodegradable core layer comprises cellulose diacetate. In another embodiment, the cellulose layer is a transparent layer.

In certain embodiments, the biodegradable core layers are formed from cellulose which is substantially continuous, more preferably non-woven and/or entangled, in structure. In yet other embodiments, the biodegradable core layers are formed from non-microbial cellulose such as cellulose regenerated from a cellulosic dispersion in a non-solvating fluid (such as but not limited to NMMO and/or a mixture of LiCl and DMP). One specific example is “viscose” which is sodium cellulose xanthate in caustic soda. Cellulose from a dispersion can be cast into film by regenerating the cellulose in situ by a suitable treatment (e.g. addition of suitable reagent which for viscose can be dilute sulphuric acid) and optionally extruding the cellulose thus formed. Such cellulose is known herein as regenerated cellulose. In other embodiments, the biodegradable core layer comprises cellulose from a wood source such as wood pulp, preferably at least 90% of the cellulosic material is from a wood source.

In certain other embodiments, the biodegradable core layer comprises PLA or a PLA derivative. In one embodiment, the PLA layer consists of only PLA. In other embodiments, the PLA layer further comprises starch in an amount sufficient to improve the rate of degradation. In some embodiments, the PLA layer comprises about 2% (w/w) to about 20% (w/w) starch.

In certain other embodiments, the PLA layer further comprises a transition metal stearate. Examples of such stearate include, but are not limited to, the stearate salt of aluminum, antimony, barium, bismuth, cadmium, cerium, chromium, cobalt, copper, gallium, iron, lanthanum, lead lithium, magnesium, mercury, molybdenum, nickel, potassium, rare earths metals, silver, sodium, strontium, tin, tungsten, vanadium, yttrium, zinc and zirconium. In some embodiments, the PLA layer comprises about 0.5% (w/w) to about 5% (w/w) metal stearate.

In certain embodiments, the biodegradable core layer is a compostable core layer. In order for a material to be designated as “compostable,” it must be demonstrated that it will biodegrade and disintegrate in a controlled composting system under standard test conditions. There are various standards, such as EN13432 standard and ASTM D6400-04 standard, covering the criteria for inclusion of biodegradable materials in compost. These standards define the degree of biodegradation that has to occur in a specified timeframe and the levels of disintegration required for the polymer within the compost. This generally means that biodegradable polymers must be used in appropriate forms (e.g. thin films) such that they can breakdown sufficiently in the timeframes specified. In a preferred embodiment, the biodegradable core layer is compostable according to the EN13432 or ASTM D6400 standard.

The biodegradable core layer may further comprise a plasticiser in an amount from about 10% to about 30%, preferably about 20% by weight of the biodegradable core layer. In certain embodiments, the plasticiser is a material which is compatible with food packaging (for example is food contact approved) and/or substantially non-toxic in the amounts used. For example the plasticiser may be selected from glycols, (such as MPG, TEG, PEG), urea, sorbitol, glycerol and/or mixtures thereof in any suitable mixtures and ratios known to those skilled in the art. In one embodiment, the plasticiser comprises such as a mixture of sorbitol and glyercol in the respective weight ratio of 60:40 by weight of solids.

The biodegradable core layer may comprise other conventional film additives and/or coatings well known in the art of film making such as those which are compatible with packaging, preferably food packaging and more preferably are food contact approved by the FDA in the US (and/or analogous agencies in other countries). Such additives and/or coatings may comprise softeners, anti-static agents, particulate additives and/or may be tinted or otherwise treated, for example impregnated with one or more other active ingredients, provided such modifications are compatible with the uses of the film as a label as described herein.

The biodegradable core layer has a thickness that is suitable for the intended application of the multi-layer biodegradable film. For example, film intended for labels should have sufficient bending stiffness to enable high speed dispensing. In certain embodiments, the biodegradable core layer has a thickness in the range of about 5-150 μm, about 10-120 μm, about 20-100 μm, about 30-80 μm, or about 40-60 μm. In one embodiment, the biodegradable core layer has a thickness of 45 μm, 50 μm or 55 μm. In certain other embodiments, the thickness of the biodegradable core layer is about 50%-95%, 60%-95%, 70%-95%, 80%-95% or 90%-95% of the total film thickness. In certain other embodiments, the biodegradable core layer is about 50%-95%, 60%-95%, 70%-95%, 80%-95% or 90%-95% by weight of the total film.

In one embodiment, the biodegradable layer comprises paper. In another embodiment, the paper is PCR paper. As used herein, the term “PCR paper” refers to paper made from a cellulose-based material that comprises PCR fibers. Briefly, PCR fibers or a mixture of PCR fibers and virgin paper fibers may be used in conventional paper making processes at the wet mixing stage and are then dried across a drum roll to form the paper sheet. The PCR fibers thereby replace a portion or all of the virgin fibers. In one embodiment, the PCR paper comprises between about 10% and about 80% PCR fibers by total weight of the paper.

In some embodiments, the multi-layer, biodegradable film comprises two biodegradable core layers bonded together by an adhesive layer.

### Biodegradable and Printable or Otherwise Functional Layer

The biodegradable, printable or otherwise functional layer comprises one or more biodegradable materials. Materials suitable for the biodegradable, printable or otherwise functional coating or skin layer include, but are not limited to, biodegradable polyesters such as PLA (Natureworks), PHBV (Tianan Biologic), PHA (Metabolix), PBAT (Eastman, BASF, DuPont), PBSA (Showa), PCL (Solvay), biodegradable polyethylene, nitrocellulose, starch based polymers. As used herein, the term “printable layer” or “printable coating” refers to a layer or coating that is receptive to ink. Such a layer or coating is constructed with a material or materials, or is subjected to special treatments, that enable the placement of an image on the layer or coating, especially through offset printing, gravure, flexography, screen process printing, letterpress printing, and the use of laser printers, laser copiers, other toner-based printers and copiers, and thermal transfer printers (e.g., resin ribbon thermal transfer, wax ribbon thermal transfer, and resin/wax thermal transfer). Moreover, the image composition may be composed of any of the inks or other compositions typically used in these printing processes (e.g., UV curable ink, toner ink compositions and ribbon compositions).

In certain embodiments provided with a printable or otherwise functional coating or skin layer, the coating is a biodegradable coating. In a preferred embodiment, the printable or otherwise functional coating or skin layer is a compostable coating. In a more preferred embodiment, the printable or otherwise functional coating or skin layer is compostable according to the EN13432 or ASTM D6400 standard.

In certain embodiments, the biodegradable, printable or otherwise functional layer comprises PLA or a PLA derivative. Due to the chiral nature of lactic acid, several distinct forms of polylactic acids, such as poly-L-lactic acid (PLLA) and poly-D-lactic acid (PDLA) exist.

PLLA is the product resulting from polymerization of L, L-lactic acid (also known as L-lactic acid). PLLA has a crystallinity of around 37%, a glass transition temperature between 60-65° C., a melting temperature between 173-178° C. and a tensile modulus between 2.7-16 GPa. PLA has similar mechanical properties to PETE polymer, but has a significantly lower maximum continuous use temperature. The melting temperature of PLLA can be increased 40-50° C. and its heat deflection temperature can be increased from approximately 60° C. to up to 190° C. by physically blending the polymer with PDLA. PDLA and PLLA form a highly regular stereocomplex with increased crystallinity. The temperature stability is maximised when a 50:50 blend is used, but even at lower concentrations of 3-10% of PDLA, there is still a substantial improvement. In the latter case, PDLA acts as a nucleating agent, thereby increasing the crystallization rate. Biodegradation of PDLA is slower than for PLA due to the higher crystallinity of PDLA. PDLA has the useful property of being optically transparent.

In other embodiments, the PLA printable or otherwise functional layer further comprises starch in an amount sufficient to improve the rate of degradation. In some embodiments, the PLA printable or otherwise functional layer comprises about 2% (w/w) to about 20% (w/w) starch. In certain other embodiments, the PLA printable or otherwise functional layer further comprises a transition metal stearate. Examples of such stearate include, but are not limited to, the stearate salt of aluminum, antimony, barium, bismuth, cadmium, cerium, chromium, cobalt, copper, gallium, iron, lanthanum, lead, lithium, agnesium, mercury, molybdenum, nickel, potassium, rare earths metals, silver, sodium, strontium, tin, tungsten, vanadium, yttrium, zinc and zirconium. In some embodiments, the PLA printable or otherwise functional layer comprises about 0.5% (w/w) to about 5% (w/w) metal stearate.

In other embodiments, the PLA printable or otherwise functional layer is also a sealable layer. In yet another embodiment, the printable or otherwise functional layer comprises a peelable sealable PLA film, such as the film described in the U.S. Patent Application Publication No. 20090169851 (which is incorporated herein by reference).

In certain other embodiments, the printable or otherwise functional coating or skin layer comprises a copolymer of lactic acid and caprolactone and suitable such copolymers are selected to provide the coated film with satisfactory peel seal characteristics. In one embodiment, the printable or otherwise functional coating or skin layer comprises a blend of two or more copolymers of lactic acid and caprolactone. Suitable copolymers for use in the coating composition singly or as part of a suitable blend include Vyloecol BE450™, Vyloecol BE410™, Vyloecol BE910™, Vyloecol BE-400™ and Vyloecol BE410™, available from Toyobo Co., Ltd, and mixtures thereof. Preferably the T_{g} of the copolymer, or blend of copolymers, is selected to be in the range of from about −10° C. to about 50° C. The molecular weight of the copolymer, or blend of copolymers, is preferably selected to be in the range of from about 20,000 to about 50,000. The hydroxyl group value of the copolymer, or blend of copolymers, is preferably from about 2 (KOH mg/g) to about 15 (KOH mg/g), more preferably from about 3 to about 11 (KOH mg/g). Biodegradable films coated with the copolymer of lactic acid and caprolactone are found to be heat-sealable (for example at seal temperatures of from about 80° C. to about 180° C.).

In certain embodiments, the coated films are transparent, with wide angle haze of less than about 10%, more preferably less than about 8%, most preferably less than about 6%. Other characteristics of the coated films, such as moisture barrier, aroma barrier, peel seal window, transparency, coating adhesion, anti-mist and other properties can be improved or adjusted by choosing or blending in an appropriate ratio the copolymers or by incorporating one or more further additives into the coating composition.

In another embodiment, the biodegradable, printable or otherwise functional coating or skin layer comprises nitrocellulose, preferably in an amount of less than about 40% w/w, more preferably less than about 30% w/w, and most preferably less than about 20% w/w of the dry weight of the coating composition.

The printable or otherwise functional coating or skin layer may contain other additional agents, if necessary, for preventing the blocking of one sheet to another, and for improving the sheet running property, antistatic property, non-transparency property, etc. These additional agents are generally added in a total amount not exceeding about 40% by weight of the water dispersible polymer. As said additional agent, for example, a pigment such as polyethylene oxide, silica, silica gel, clay, talc, diatomaceous earth, calcium carbonate, calcium sulfate, barium sulfate, aluminium silicate, synthetic zeolite, alumina, zinc oxide, titanium oxide, lithopone, satin white, etc. and cationic, anionic and nonionic antistatic agents, etc. may be used.

When used as a packaging film, the printable or otherwise functional layer of the present invention may further comprises one or more waxes, preferably in an amount of less than 10% w/w, more preferably less than about 5% w/w, and most preferably less than about 4% w/w of the dry weight of the printable or otherwise functional layer composition. Suitable waxes include Distec wax, paraffin wax, carnauba wax, candelilla wax, montan waxes, micro crystalline waxes and others.

Another additive which may desirably be incorporated in the printable or otherwise functional layer composition is an antiblock additive, preferably present in an amount of less than about 5% w/w, more preferably less than about 4% w/w, and most preferably less than about 3% w/w of the dry weight of the printable or otherwise functional layer composition. Preferred antiblock additives include mineral agents such as silica and calcined kaolin. The coating composition is preferably applied to the substrate from a solution of the dry weight component(s) in a suitable solvent or solvent mixture.

In certain embodiments, the printable or otherwise functional layer is applied to the biodegradable core layer after or during casting thereof. In one embodiment, the printable or otherwise functional layer is applied to the biodegradable core layer by co-extrusion. In another embodiment, the printable or otherwise functional layer is applied as an aqueous dispersion at about 0.5 to about 2.5 g/m² onto the biodegradable core layer by the method of roll coating, blade coating, spray coating, air knife coating, rod bar coating, reverse gravure, etc. on the core layer and then dried, for example, in a hot air oven. The printable or otherwise functional layer may be applied on one side or both sides of the biodegradable core layer.

In certain embodiments, the printable or otherwise functional coating or skin layer has a thickness of about 0.5-20 μm, about 0.5-10 μm, about 1-5 μm or about 2-3 μm.

In certain other embodiments, the printable or otherwise functional coating or skin layer is printed with a biodegradable ink. Examples of biodegradable ink include, but are not limited to, PLA or PHA based ink composition, such as those described in U.S. Patent Application Publication No. 20050215662, which is incorporated herein by reference. Commercially available biodegradable inks include the hybrid inks from Sun Chemicals (Parsippany, N.J.).

### Surface Treatment

Before applying the printable or otherwise functional layer, the surface of the biodegradable core layer can be first pretreated in a conventional manner with a view to improve its adhesiveness. In certain embodiments, the biodegradable core layer is subjected to a surface treatment such as oxidation treatment, film chlorination, i.e., exposure of the film to gaseous chlorine; roughening treatment or primer treatment on one or both faces so that adhesion with the releasing layer formed on the substrate layer is improved. Examples of oxidation treatment include treatment by corona discharge, treatment by plasma discharge, treatment with chromic acid (a wet process), treatment with flame, treatment with heated air and treatment with ozone under irradiation with ultraviolet light. Examples of roughening treatment include sandblasting treatment and treatment with a solvent. The surface treatment is suitably selected in accordance with the type of the substrate layer. In one embodiment, the surface treatment is corona discharge. In another embodiment, the surface treatment is the so-called electronic treatment in which the sheet is passed between a pair of spaced electrodes to expose the sheet surface to a high voltage electrical stress accompanied by corona discharge.

In certain embodiments, a primer is used as an intermediate between the biodegradable core layer and the printable or otherwise functional layer to provide a high level of adherence. Examples of suitable primers include, but are not limited to, titanates, polyethylene imine or polyurethane acrylate primers crosslinked by isocyanate, epoxy, aziridine or silane derivatives may be cited. The primer resin may be applied by conventional coating techniques, e.g., by a gravure roll coating method. The resin is conveniently applied as a dispersion or as a solution. Economically it would be preferable to apply the resin as a dispersion in water. Aqueous dispersion techniques have the added advantage that there is no residual odour due to the solvent present which is generally the case when an organic solvent is used. However, when using aqueous techniques, it is usually necessary to heat the film a higher temperature to dry off the dispersant than with systems using an organic solvent or dispersant. Furthermore, the presence of a surfactant, which is generally used to improve the dispersion of the coating in water, tends to reduce the adhesion between the resin and the base film. Thus, it is also possible to apply the resin from an organic solvent or dispersant. Examples of suitable organic solvents include alcohols, aromatic hydrocarbon solvents, such as xylene, or mixtures of such solvents as is appropriate.

### Printing Methods and Ink Composition

The film with a printable or otherwise functional layer may be printed by conventional methods such as offset printing, screen printing, electrostatic printing, electrophotographic printing (including laser printing and xerography); ion deposition printing, also referred to as electron beam aging (EBI); magnetographics, ink-jet printing, and thermal mass transfer printing, gravure, flexography, and letterpress printing using radiation curable ink and subsequently radiation cured. Since each printing method has its own requirement for the receptive surface, the composition of the printable or otherwise functional layer may be adjusted to adapt the special needs of a particular printing method.

For example, criteria that an ideal ink-jet receptive substrate will possess include some or all of the following, depending on the particular application (e.g. for a “no-label” look transparency is important rather than whiteness or opacity). A suitable ink-jet printable or otherwise functional layer will have good optical properties such as brightness, whiteness, gloss, opacity and/or color gamut to give high-quality printed images. The printable or otherwise functional layer should be compatible with components in the ink to ensure that the final ink image has sufficient fastness and low tendency to fade for example when exposed to UV light. The absorbency of the film surface is important. Ink jet printing places special demands on the substrate which is printed with a large amount of liquid, and yet is expected to dry quickly without changing size or shape. Although paper fibres absorb liquid well, but they swell and deform, resulting in surface imperfections and such moisture-induced undulations have a detrimental effect on image quality. A suitable printable or otherwise functional coating or skin layer is durable and will maintain its structure at the time of the print. The durability is determined by its dimensional stability, tear resistance, thermal stability, and water and light resistance. For example, in order to produce a good image by an ink jet printer the ink receiving surface should be dimensionally and thermally stable, i.e. not tear, stretch or deform, should be smooth and waterproof, maintain its shape and be resistant to many chemicals and should not swell or shrink with moisture or humidity.

The roughness of the printable or otherwise functional layer can be generated mechanically, for example by embossing, or by chemically modifying the surface of the printable or otherwise functional layer, for example by applying a porous layer. Inkjet or “microporous” coatings that are known to the skilled person can be mentioned here as examples of such a porous coating.

Ink formulations for radiation curing contains generally pigments, vehicle, solvent and additives. The solvents in these systems are low-viscosity monomers, capable of reacting themselves (i.e., used as reactive diluents). The vehicle is usually composed of a resin derived from unsaturated monomers, prepolymers or oligomers such as acrylates derivatives which are able to react with the ethylenically unsaturated compound of the surface layer. For a UV ink, the “additives” contain a large amount of photoinitiators which respond to the photons of UV light to start the system reacting.

In one embodiment, the UV ink formulation contains 5-20% pigment, 20-35% prepolymers, 10-25% vehicle, 2-10% photoinitiators and 1-5% other additives. As noted earlier, all the percentages are based on dry weight. In another embodiment, the ink is an electron beam curable ink and contains no photoinitiator.

The low viscosity monomers, sometimes termed diluents, are capable of chemical reactions which result in their becoming fully incorporated into the ultimate polymer matrix.

The vehicle provides the “hard resin” portion of the formulation. Typically, these are derived from synthetic resins such as for example, urethanes, epoxides, polyesters which have been modified by reaction with compounds bearing ethylenic groups such as for instance (meth)acrylic acid, hydroxyethyl(meth)acrylate reaction product of caprolactone with unsaturated compounds bearing a hydroxyl group, and the like. Appropriate adjustments could be made in the selection of the prepolymers and monomers used in order to achieve the required viscosities for the different methods of application.

### Biodegradable, Heat Sealable Coating Layer

In certain embodiments, the printable or otherwise functional layer is printed with an ink and then coated with a biodegradable, heat sealable coating layer. In one embodiment, the sealable, biodegradable, coating layer comprises a copolymer of lactic acid and caprolactone and suitable such copolymers are selected to provide the film with satisfactory seal and printing characteristics. One preferred coating in accordance with the invention comprises a blend of two or more copolymers of lactic acid and caprolactone. Suitable copolymers for use in the coating composition singly or as part of a suitable blend include Vyloecol BE-450™, Vyloecol BE-410™, Vyloecol BE-910™, Vyloecol BE-406™ and Vyloecol BE-410™, available from Toyobo Co., Ltd, and mixtures thereof.

Preferably the T_{g} of the copolymer, or blend of copolymers, is selected to be in the range of from about −10° C. to about 50° C. The molecular weight of the copolymer, or blend of copolymers, is preferably selected to be in the range of from about 20,000 to about 50,000. The hydroxyl group value of the copolymer, or blend of copolymers, is preferably from about 2 (KOH mg/g) to about 15 (KOH mg/g), more preferably from about 3 to about 11 (KOH mg/g). Films coated with such a coating layer is heat-sealable at seal temperatures of from about 80° C. to about 180° C.

Characteristics of the sealable coating layer, such as moisture barrier, aroma barrier, peel seal window, transparency, coating adhesion, anti-mist and other properties can be improved or adjusted by choosing or blending in an appropriate ratio the copolymers or by incorporating one or more further additives into the sealable coating layer composition.

In one embodiment, the sealable coating composition comprises an antiblock additive, preferably present in an amount of less than about 5% w/w, more preferably less than about 4% w/w, and most preferably less than about 3% w/w of the dry weight of the coating composition. Preferred antiblock additives include mineral agents such as silica and calcined kaolin. The coating composition is preferably applied to the substrate from a solution of the dry weight component(s) in a suitable solvent or solvent mixture.

Still further additives comprise slip aids such as hot slip aids or cold slip aids which improve the ability of a film to satisfactorily slide across surfaces at about room temperature for example micro-crystalline wax. Preferably the wax is present in the coating in an amount from about 0.5% to about 5.0% w/w, more preferably from about 1.5% to about 2.5% w/w. The wax particles may have an average size conveniently from about 0.1 μm to 0.6 μm, more conveniently from about 0.12 μm to about 0.30 μm.

Yet further additives comprise conventional inert particulate additives, preferably having an average particle size of from about 0.2 μm to about 4.5 μm, more preferably from about 0.7 μm to about 3.0 μm. Decreasing the particle size improves the gloss of the film. The amount of additive, preferably spherical, incorporated into the or each layer is desirably in excess of about 0.05%, preferably from about 0.1% to about 0.5%, for example, about 0.15%, by weight. Suitable inert particulate additives may comprise an inorganic or an organic additive, or a mixture of two or more such additives.

Suitable particulate inorganic additives include inorganic fillers such as talc, and particularly metal or metalloid oxides, such as alumina and silica. Solid or hollow, glass or ceramic micro-beads or micro-spheres may also be employed. A suitable organic additive comprises particles, preferably spherical, of an acrylic and/or methacrylic resin comprising a polymer or copolymer of acrylic acid and/or methacrylic acid. Such resins may be cross-linked, for example by the inclusion therein of a cross-linking agent, such as a methylated melamine formaldehyde resin. Promotion of cross-linking may be assisted by the provision of appropriate functional groupings, such as hydroxy, carboxy and amido groupings, in the acrylic and/or methacrylic polymer.

Yet still further additives comprise fumed silica for the purpose of further reducing the tack of a coating at room temperature. The fumed silica is composed of particles which are agglomerations of smaller particles and which have an average particle size of, for example, from about 2 μm to about 9 μm, preferably from about 3 μm to about 5 μm, and is present in a coating in an amount, for example, from about 0.1% to about 2.0% by weight, preferably about 0.2% to about 0.4% by weight.

Some or all of the desired additives listed above may be added together as a composition to coat the sheet of the present invention and/or form a new layer which may itself be coated (i.e. form one of the inner layers of a final multi-layered sheet) and/or may form the outer or surface layer of the sheet. Alternatively some or all of the preceding additives may be added separately and/or incorporated directly into the bulk of the sheet optionally during and/or prior to the sheet formation (e.g. incorporated as part of the original polymer composition by any suitable means for example compounding, blending and/or injection) and thus may or may not form layers or coatings as such. These conventional other coatings and/or layers may thus be provided on top of or underneath the gas barrier coatings of the present invention and may be in direct contact thereto or be separated by one or more other intermediate layers and/or coats.

Formation of a film of the invention (optionally oriented and optionally heat-set as described herein) which comprises one or more additional layers and/or coatings is conveniently effected by any of the laminating or coating techniques well known to those skilled in the art. For example a layer or coating can be applied to another base layer by a coextrusion technique in which the polymeric components of each of the layers are coextruded into intimate contact while each is still molten. Preferably, the coextrusion is effected from a multi-channel annular die such that the molten polymeric components constituting the respective individual layers of the multi-layer film merge at their boundaries within the die to form a single composite structure which is then extruded from a common die orifice in the form of a tubular extrudate.

Coatings and/or layers may be applied to either or both surfaces of the biodegradable core layer. Each coating and/or layer may be applied sequentially, simultaneously and/or subsequently to any or all other coatings and/or layers. For example, if a heat sealable coating is applied to only one side of the biodegradable core layer, other coatings and/or layers may be applied either to the same side of the biodegradable core layer and/or on the opposite side of the biodegradable core layer.

The sealable coating layer is ordinarily applied in such an amount that there will be deposited following drying, a smooth, evenly distributed layer having a thickness of from about 0.02 to about 10 μm, preferably from about 1 to about 5 μm. In general, the thickness of the applied coating is such that it is sufficient to impart the desired characteristics to the substrate sheet. Once applied to the sheet a coating may be subsequently dried by hot air, radiant heat or by any other suitable means to provide a sheet of the present invention with the properties desired (such as an optionally clear; optionally substantially water insoluble; highly oxygen impermeable coated film useful, for example in the fields of authentication, packaging, labelling and/or graphic art).

### Pressure Sensitive Adhesive Layer and Release Film

In certain embodiments, the biodegradable core layer is covered at least on one side with a pressure sensitive adhesive layer. In one embodiment, the biodegradable core layer is covered on only one side with the pressure sensitive adhesive layer. In another embodiment, the biodegradable core layer is covered on both sides with the pressure sensitive adhesive layer.

The pressure-sensitive adhesive layer comprises a pressure-sensitive adhesive composition. The pressure-sensitive adhesive composition used in the pressure-sensitive adhesive layer is not specifically restricted and conventional pressure-sensitive adhesive compositions can be used. In certain embodiments, the pressure sensitive adhesive compositions comprise an acryl type copolymer and a cross-linking agent.

The acryl type copolymer includes copolymers of one or more alkyl esters of (meth)acrylate, the carbon atom number of the alkyl group being 4 to 18 and one or more of other monomer containing polymerizable ethylenically unsaturated bond, etc.

Examples of the monomers of alkyl esters of (meth)acrylate include methyl ester, ethyl ester, propyl ester, isopropyl ester, butyl ester, isobutyl ester, s-butyl ester, t-butyl ester, pentyl ester, isopentyl ester, hexyl ester, heptyl ester, octyl ester, 2-ethyl hexyl ester, iso-octyl ester, nonyl ester, decyl ester, isodecyl ester, undecyl ester, dodecyl ester, tridecyl ester, tetradecyl ester, hexadecyl ester, octadecyl ester, eicosyl ester, other alkyl radicals with 1 to 30 carbon atoms, straight chain or branch chain alkyl ester with 4 to 18 carbon atoms, and (meth)acrylic cycloalkyl ester (for example, cyclopentyl ester, cyclohexyl ester). These materials may be used either alone or in combination of two or more types. As used herein, the term “(meth)acrylate” refers to acrylate and/or methacrylate.

In certain embodiments, the pressure-sensitive adhesive composition comprises copolymerizable monomers containing an ethylenically unsaturated bond. Examples of the copolymerizable monomer containing an ethylenically unsaturated bond include acrylonitrile, methyl(meth)acrylate, ethyl(meth)acrylate, propyl(meth)acrylate, isopropyl(meth)acrylate, cyclohexyl(meth)acrylate, styrene, α-methyl styrene, vinyl acetate, N-vinyl-2-pyrrolidone, benzyl(meth)acrylate, 2-hydroxyethyl(meth)acrylate, 2-hydroxypropyl(meth)acrylate, acrylic acid, methacrylic acid, itaconic acid, and fumaric acid.

Examples of the cross-linking agent in order to cross-link an acryl type copolymer in the adhesive composition of the present invention include an isocyanate type cross-linking agent including a diisocyanate compound such as hexamethylene diisocyanate, xylylene diisocyanate, tolylene diisocyanate, 2-chloro-1,4-phenyl diisocyanate, trimethylhexamethylene diisocyanate, 1,5-naphthalene diisocyanate and isophorone diisocyanate, a biuret trimer and an isocyanurate type trimer of these diisocyanate compounds, and triisocyanates, epoxy type cross-linking agents, a melamine type cross-linking agent, a metal chelate type cross-linking agents, and adducts of a polyol such as trimethylol propane, and a suitable one can appropriately be selected for use.

The pressure-sensitive adhesive composition may also contain multifunctional monomers for crosslinking purpose. Such multifunctional monomers include, for example, hexane diol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylol propane tri(meth)acrylate, pentaerythritol tri(meth)acrylate, dipentaerythritol hexa(meth)acrylate, epoxy (meth)acrylate, polyester (meth)acrylate, urethane (meth)acrylate, etc. These multifunctional monomers may be also used either alone or in combination of two or more types. The amount of the multifunctional monomers is preferred to be 30 wt. % or less of the total monomer components from the viewpoint of adhesive property, etc.

In other embodiments, the pressure-sensitive adhesive composition further comprises a tackifier resin. Examples of the tackifier resin include a rosin type resin such as rosin, a rosin phenol resin, and its esterified product and its metal salt, a terpene type polymer such as a terperene polymer, a terpene-phenol resin and an aromatic modified terpene resin, a styerene type resin, a coumarone/indene resin, an alkylphenol resin, a xylene resin, a C5 type petroleum resin, C9 type petroleum resin, and an alicyclic hydrogenated resin, among which a natural resin type such as a rosin type resin and a terpene type resin are preferably used because they are excellent in compatibility with an acryl type copolymer and show good adhesive force and an initial tackiness to a receiving object such as paper and various films upon incorporating in the acryl type copolymer.

In one embodiment, the pressure-sensitive adhesive layer comprises a radiation curable adhesive composition which may be cured by radiation such as X-ray, ultraviolet (UV) light, visible light or electron ray. In one embodiment, the photo curable adhesive composition is a UV-curable adhesive composition.

In certain embodiments, the radiation curable, pressure-sensitive adhesive composition comprises an acrylic adhesive or rubber adhesive, blended with radiation curing type monomer components or oligomer components.

Examples of radiation curing type monomer components for forming the acrylic adhesive include urethane oligomer, urethane(meth)acrylate, trimethylol propane tri(meth)acrylate, tetramethylol methane tetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, 1,4-butane diol di(meth)acrylate, and others. Radiation curing oligomer components include various oligomers of, for example, urethane type, polyether type, polyester type, polycarbonate type, and polybutadiene type, and the component of molecular weight of about 100 to 30000 is preferred. The blending amount of radiation curing monomer component or oligomer component may be properly determined to lower the adhesive force of the adhesive layer depending on the type of the adhesive layer. Generally, in 100 parts by weight of the base polymer such as acrylic polymer composing the adhesive agent, it is preferred to add 0.1 to 200 parts by weight, more preferably 0.1 to 150 parts by weight.

In certain embodiments, the pressure-sensitive adhesive layer is covered by a release film comprising a substrate layer and a releasing layer formed on the substrate layer. In other embodiments, the pressure-sensitive adhesive layer is transferred to the biodegradable core layer from a release liner with which the biodegradable core layer is combined.

The substrate used in the release film is not particularly limited and can be suitably selected from compositions conventionally used as the substrate layer of release films. Examples of the substrate layer include films of polyesters such as polyethylene terephthalate, polybutylene terephthalate and polyethylene naphthalate, polyethylene films, polypropylene films, polyvinyl chloride films, polyvinylidene chloride films, polyvinyl alcohol films, ethylene-vinyl acetate copolymer films, polystyrene films, polycarbonate films, polymethylpentene films, polysulfone films, polyether ether ketone films, polyether sulfone films, polyphenylene sulfide films, polyether imide films, polyimide films, fluororesin films, polyamide films, acrylic resin films, norbornene-based resin films and cycloolefin resin films.

The thickness of the substrate layer is not particularly limited and suitably selected in accordance with the application. In general, the thickness is 10 to 150 μm and preferably 20 to 120 μm.

In another embodiment, the substrate layer comprises a paper layer.

The releasing layer comprises a releasing agent. In certain embodiments, the releasing agent is a silicone-based releasing agent, such as polyorganosiloxanes. The thickness of the releasing agent layer comprising the silicone-based releasing agent is, in general, about 0.01 to 3 μm and preferably 0.03 to 1 μm.

In other embodiments, the releasing agent is a non-silicone-based releasing agent. Examples of releasing agents include, but are not limited to, releasing agents based on compounds having a long chain alkyl group, such as polyvinyl carbamate, alkyd resin-based releasing agents, olefin resin-based releasing agents, rubber-based releasing agents and acrylic releasing agents.

Alkyd resin-based releasing agents typically contain an alkyd resin obtained by condensation of a polyhydric alcohol and a polybasic acid. Examples of polyhydric alcohols include dihydric alcohols such as ethylene glycol, diethylene glycol, triethylene glycol, propylene glycol, trimethylene glycol, tetra ethylene glycol and neopentyl glycol, trihydric alcohols such as glycerol, trimethylolethane and trimethylolpropane, and polyhydric alcohols having a functionality of four or greater such as diglycerol, triglycerol, pentaerythritol, dipentaerythritol, mannit and sorbit. The polyhydric alcohol may be used singly or in combination of two or more.

Examples of polybasic acids include aromatic polybasic acids such as phthalic anhydride, terephthalic acid, isophthalic acid and trimellitic anhydride, aliphatic saturated polybasic acids such as succinic acid, adipic acid and sebacic acid, aliphatic unsaturated polybasic acids such as maleic acid, maleic anhydride, fumaric acid, itaconic acid and citraconic anhydride, and polybasic acids obtained by the Diels-Alder reaction such as addition products of cyclopentadiene and maleic anhydride, addition products of terpene and maleic anhydride and addition products of rosin and maleic acid. The polybasic acid may be used singly or in combination of two or more.

The olefin resin-based releasing agents may contain a crystalline olefin-based resin. In one embodiment, the crystalline olefin-based resin is crystalline polypropylene-based resin.

The rubber-based releasing agents may contain a natural rubber-based resin or a synthetic rubber-based resin such as butadiene rubber, isoprene rubber, styrene-butadiene rubber, methyl methacrylate-butadiene rubber and acrylonitrile-butadiene rubber.

The acrylic releasing agents may contain a (meth)acrylic ester-based copolymer having a crosslinking functional group. In one embodiment, the (meth)acrylic ester-based copolymer has a weight-average molecular weight to 300,000 or greater.

In another embodiment, the releasing agent further comprises an electrically conductive material such as carbon fibers.

### Barrier Layer

The multi-layer biodegradable film may contain one or more barrier layers. Preferably, the barrier layer is a biodegradable layer. In certain embodiments, the printable or otherwise functional layer also serves as a barrier layer. The barrier layer exhibits at least one barrier property—either to moisture, or to air or gases generally, or to light (UV or otherwise). Commonly used barrier layer materials include aluminum, poly vinyl alcohol such as ethylene vinyl alcohol (EVOH), vinyl chloride/vinyl acetate copolymer, nitrocellulose, PVdC, polybutylene succinate (PBS), polycaprolactone, (PCL), polyanhydrides, polyvinyl silicon based materials such as silicon oxides (SiOₓ) and silicon nitride (Si₃N₄).

In one embodiment, the barrier layer is a metalized coating formed on a surface of the biodegradable core layer. The metalized coating may cover the full surface or only a portion of the surface of the biodegradable core layer.

Metalization processes are known to the person skilled in the art. The usual method here uses metal, such as aluminum, deposited from the vapor in vacuo onto a web substrate. The metal deposits on the web substrate, thus forming a thin film. By way of example, a prefabricated web substrate, such as a biodegradable polymer film, can be introduced into a vacuum chamber and a vacuum in the range from 10⁻⁴ to 10⁻⁵ bar can be generated with the aid of suitable pumps. The metal, such as aluminum, is then heated to a temperature in the range from 1400 to 1500° C., thus producing a cloud of metal vapors in the vacuated space through which the polymer film is passed. A very thin metal layer is thus deposited on the surface of the polymer film. It is preferable here that one entire surface of the polymer film is metalized. The thickness of the metal film can be adjusted by varying the temperature, vacuum, geometry of the vacuum chamber, and speed of the polymer film passing through the metal vapor. The thickness of the metal film can be measured either electrically or optically.

In another embodiment, the barrier layer comprises a metal oxide (e.g., AlOₓ) or a semimetal oxide (e.g., SiOₓ). The coating process can be carried out by way of example by chemical vapor deposition (CVD) or physical vapor deposition (PVD). These processes are known to the person skilled in the art. By way of example, it is possible to vaporize aluminum in vacuo and to deposit AlOₓ by adding a certain amount of oxygen. In the case of silicon, the material can be vaporized with the aid of an electron beam.

The average thickness of the multi-layer biodegradable film of the present invention may be up to about 2 μm (e.g. if a foamed film is used), preferably up to about 50 μm. In certain embodiments, the multi-layer biodegradable film has an average thickness from about 10 to about 100 μm, from about 10 to about 70 μm, and from about 20 to about 50 μm. In one embodiment, the multi-layer biodegradable film is a duplex laminated films (i.e. where a single web is laminated onto itself) to provide desired stiffness.

It would also be possible to use combinations of more than one of the above methods of applying additives and/or components thereof to a film. For example one or more additives may be incorporated into the resin prior to making the film and the one or more other additives may be coated onto the film surface.

Preferably, the multi-layer film of the present invention is certifiably biodegradable. This means either that the film is completely biodegradable, or the total weight of non-biodegradable components in the film is sufficiently low for the film as a whole to be considered biodegradable according to conventional standards at the present time.

### Method of Making the Multi-Layer, Biodegradable Film

Another aspect of the present invention relates to a method for producing a biodegradable multi-layer film. The method comprises the steps of covering a cellulose core layer with a biodegradable printable or otherwise functional layer by extrusion coating, printing on the printable or otherwise functional layer with a biodegradable ink to form an ink layer and, optionally, coating the ink layer with a sealable coating layer. In one embodiment, the biodegradable printable or otherwise functional layer comprises PLA or a PLA derivative. In another embodiment, the sealable coating layer comprises a copolymer of lactic acid and caprolactone. In yet another embodiment, the cellulose core layer is a metalized cellulose layer.

The present invention is further illustrated by the following example which should not be construed as limiting. The contents of all references, patents and published patent applications cited throughout this application are incorporated herein by reference.

### Example 1

### Biodegradable Polyester Coating for Cellulose Films

A trial run was carried out using a cellulose film sample (Sample 1) and a biodegradable polyester. Briefly, a lacquer formulation (Formulation 1) was prepared by mixing the biodegradable polyester with minor amounts of maleic acid and of a compatible wax and antiblock in a THF:toluene blend at 55° C. The cellulose film was coated with the lacquer at 55° C. The physical properties of the coated films are shown in Table 1.

In another trial run, three other cellulose film samples (Samples 2-4) were coated with the same biodegradable polyester in lacquer formulation 2 or formulation 3. Briefly, the lacquer formulations were prepared with the biodegradable polyester at 60° C. The cellulose films were coated with the lacquer at 55° C. The physical properties of the coated films are shown in Table 2. The haze, gloss, and seal strength values are all within the desired ranges. The printability of these samples was tested using three ink systems, NC urethane, PVB and CAP/acrylic. The CAP/Acrylic system seems to give the best adhesion and printability.

In yet another trial run, two other cellulose film samples (Sample 5 and Sample 6) were coated with the biodegradable polyester using lacquer formulation 3. The physical properties of the coated films are shown in Table 3. The haze, gloss, and seal strength values are all within the desired ranges. The printability of these samples was tested using three ink systems, NC urethane, PVB and CAP/acrylic. The CAP/Acrylic system seems to give the best adhesion and printability.

TABLE 1

| | | Film Type | | | | |
|---|---|---|---|---|---|---|
| | | Sample 1 | Sample 1 | Sample 1 | Sample 1 | |
| | | Lacquer Type | | | | |
| | | Formulation 1 | Formulation 1 | Formulation 1 | Formulation 1 | Ave |
| Coat Gain | g/m2 | 2 | 1.9 | 1.9 | 2.7 | 2.1 |
| Haze | % | 4.7 | 4.2 | 4.1 | 5.4 | 4.6 |
| WVP Tropical | 38° C. 90% RH | 107 | 78 | 94 | — | 93.0 |
| Corrected to | 1.9 g/m2 | 113 | 78 | 94 | — | 94.9 |
| Temperate | 25° C. 75% RH | 30 | 28 | 58 | — | 38.7 |
| Corrected to | 1.9 g/m2 | 32 | 28 | 58 | — | 39.2 |
| Heat Seal | 135° C. | 500+ | 500+ | 500+ | 500+ | 500+ |
| (10 psi, 0.5 sec) | 100° C. | 500+ | 500+ | 500+ | 500+ | 500+ |
| H S T | ° C. | 65 | — | 65 | — | 65.0 |
| Hot Tack (135° C., | G | 150 | 150 | 150 | 150 | 150.0 |
| 2.5 sec, 10 psi) | | | | | | |
| H S J R | 110° C. | 10 | 3 | 4 | 8 | 6 |
| | 130° C. | 7 | 5 | 4 | 8 | 6 |
| | 150° C. | 11 | 6 | 6 | 11 | 9 |
| Pressure Block | ?/50 | 40 | 41 | 34 | 35 | 38 |
| C O F | A-A static | 0.45 | 0.33 | 0.42 | 0.29 | 0.37 |
| | A-B static | 0.43 | 0.35 | 0.35 | 0.35 | 0.37 |
| | B-B static | 0.33 | 0.37 | 0.34 | 0.28 | 0.33 |
| | A-A dynamic | 0.35 | 0.3 | 0.34 | 0.23 | 0.31 |
| | A-B dynamic | 0.32 | 0.31 | 0.32 | 0.3 | 0.31 |
| | B-B dynamic | 0.31 | 0.32 | 0.29 | 0.28 | 0.30 |
| Ink Key* | ° C. | 49 | | 49 | | 49 |

*Ink Used: Coates Lorilleux Mercury, formulated for polyester. Viscosity reduced using 3:2 IMS:n-propyl alcohol.

TABLE 2

| | | Film Type | | | | | | | | | |
|---|---|---|---|---|---|---|---|---|---|---|---|
| | | Sample | Sample | Sample | | Sample | Sample | Sample | Sample | Sample | |
| | | 4 | 4 | 2 | | 3 | 3 | 3 | 3 | 3 | |
| | | Lacquer Type | | | | | | | | | |
| | | Formu- | Formu- | Formu- | | Formu- | Formu- | Formu- | Formu- | Formu- | |
| | | la. 3 | la. 3 | la. 3 | Ave | la. 2 | la. 2 | la. 2 | la. 2 | la. 2 | Ave |
| Coat Gain (wash off) | g/m2 | 1.7 | 2.1 | 2.6 | 2.1 | 2.5 | 2.3 | 1.9 | 2.1 | 2.2 | 2.2 |
| Haze (wide Angle) | % | 4.5 | 3.8 | 4.8 | 4.4 | 4 | 4.4 | 4.2 | 7.0 | 7.1 | 5.3 |
| Gloss | % | 93 | 93 | 93 | 93.0 | 92 | 91 | 91 | 94 | 94 | 92.4 |
| WVP g/m2/day* | Day 1 | 314 | 218 | 270 | 267 | 41 | 39 | 35 | 61 | 50 | 45 |
| WVP g/m2/day* | Day 2 | 280 | 205 | 262 | 249 | 37 | 36 | 32 | 44 | 38 | 37 |
| WVP g/m2/day* | Day 3 | 227 | 168 | 214 | 203 | 40 | 33 | 30 | 41 | 36 | 36 |
| WVP g/m2/day* | Average | 274 | 197 | 249 | 240 | 39 | 36 | 32 | 49 | 41 | 40 |
| WVP Corrected | 1.9 g/m² | 245 | 218 | 340 | 268 | 52 | 44 | 32 | 54 | 48 | 46 |
| Std Heat Seal | 135° C. g/38 mm | 580 | 610 | 640 | 610 | 700 | 730 | 730 | 750 | 640 | 710 |
| Std Heat Seal | 100° C. g/38 mm | 470 | 420 | 460 | 450 | 460 | 410 | 420 | 420 | 430 | 428 |
| | 80° C. | 430 | 420 | 440 | 430 | 420 | 390 | 400 | 400 | 400 | 402 |
| | 70° C. | 50 | 60 | 50 | 53 | 40 | 50 | 50 | 60 | 50 | 50 |
| H S T (90 g seal) | ° C. | 71 | 71 | 71 | 71 | 71 | 71 | 71 | 71 | 71 | 71 |
| Low Pressure Seals | 110° C. g/38 mm | 670 | 650 | 580 | 633 | 590 | 580 | 640 | 640 | 670 | 624 |
| Std Seal A/B g/25 mm | 100° C. g/25 mm | — | 405 | 445 | 425 | — | 470 | — | — | — | 470 |
| Fridge Seals A/B | 100° C. g/25 mm | — | 340 | 400 | 370 | — | 470 | — | — | — | 470 |
| Tropical Seals A/B | 100° C. g/25 mm | — | 125 | 90 | 108 | — | 90 | — | — | — | 90 |
| Hot Tack | Grams | 150 | 150 | 150 | 150 | 150 | 150 | 150 | 150 | 150 | 150 |
| H S J R | 110° C. | 34 | 34 | 36 | 35 | 47 | 52 | 49 | 31 | 33 | 42 |
| g/25 mm | 130° C. | 24 | 28 | 25 | 26 | 39 | 38 | 35 | 24 | 26 | 32 |
| | 150° C. | 17 | 17 | 17 | 17 | 18 | 16 | 21 | 17 | 16 | 18 |
| P Block | ?/30 | 30 | 30 | 29 | 30 | 30 | 30 | 30 | 29 | 30 | 30 |
| C O F | A-A | 0.3125 | 0.3255 | 0.3304 | 0.32 | 0.33 | 0.33 | 0.34 | 0.29 | 0.28 | 0.31 |
| | A-B | 0.3147 | 0.3283 | 0.3364 | 0.33 | 0.34 | 0.34 | 0.35 | 0.30 | 0.31 | 0.33 |
| | B-B | 0.3100 | 0.3059 | 0.3247 | 0.31 | 0.34 | 0.34 | 0.34 | 0.30 | 0.30 | 0.32 |
| Dyne Level | Unmetalised | 34 | — | 32 | 33 | — | <31 | — | — | — | |
| Dyne Level (Metal) | Day 1 | >58* | — | 42* | | — | DM | — | — | — | |
| Dyne Level (Metal) | Day 7 | 36 | — | 54 | 45.0 | — | DM | — | — | — | |
| Metal Pull Off % | Day 1 | 100 | — | 100 | 100.0 | — | DM | — | — | — | |
| Metal Pull Off % | Day 7 | 100 | — | 100 | 100.0 | — | DM | — | — | — | |

WVP* Sample 3: measured under Tropical conditions, Samples 2 and 4: measured under Temperate conditions; DM: did not metalize

| Ink Keys | INK TYPE | | | | |
|---|---|---|---|---|---|
| Lacquer Code | nc Acrylic | nc polyamide | nc urethane | CAP acrylic | PVB |
| Formulation 2 | 48° C. | 48° C. | 41° C. | 40° C. | 42° C. |
| Formulation 3 | <25° C. | <25° C. | <25° C. | <25° C. | <25° C. |

TABLE 3

| | | Film Type | | | | | | | | |
|---|---|---|---|---|---|---|---|---|---|---|
| | | Sample 5 | Sample 5 | Sample 5 | Sample 5 | Sample 5 | Sample 6 | Sample 6 | Sample 6 | |
| | | Lacquer Code | | | | | | | | |
| | | Formula. | Formula. | Formula. | Formula. | Formula. | Formula. | Formula. | Formula. | |
| | | 3 | 3 | 3 | 3 | 3 | 3 | 3 | 3 | Ave |
| Coat Gain (wash off) | g/m2 | 1.54 | 1.73 | 1.76 | 1.64 | 1.96 | 2.0 | 1.50 | 2.01 | 1.8 |
| Haze (wide Angle) | % | 3.6 | 4.2 | 3.6 | 3.9 | 3.8 | 5.4 | 3.8 | 5.3 | 4.2 |
| Gloss | % | 96 | 92 | 94 | 96 | 93 | 95 | 95 | 96 | 94.6 |
| WVP g/m2/day* | Day 1 | 362 | 363 | 345 | 309 | 378 | 297 | 384 | 276 | 339 |
| WVP g/m2/day* | Day 2 | 309 | 301 | 290 | 263 | 314 | 261 | 321 | 238 | 287 |
| WVP g/m2/day* | Day 3 | 270 | 268 | 256 | 233 | 278 | 238 | 285 | 214 | 255 |
| WVP g/m2/day* | Average | 314 | 311 | 297 | 268 | 323 | 265 | 330 | 243 | 294 |
| WVP Corrected | 1.9 g/m2 | 254 | 283 | 275 | 232 | 334 | 279 | 261 | 257 | 272 |
| Std Heat Seal | 135° C. g/38 mm | 270 | 325 | 350 | 340 | 295 | 345 | 430 | 485 | 355 |
| Std Heat Seal | 100° C. g/38 mm | 400 | 425 | 420 | 315 | 335 | 315 | 485 | 455 | 394 |
| H S T (90 g seal) | ° C. | 69 | 69 | 69 | 69 | 69 | 69 | 69 | 69 | 69 |
| Low Pressure Seals | 110° C. g/38 mm | 383 | 303 | 320 | 330 | 277 | 330 | 367 | 283 | 324 |
| Std Seal A/B | 100° C. g/25 mm | 250 | 203 | 173 | 183 | 213 | 213 | 193 | 253 | 210 |
| Fridge Seals A/B | 100° C. g/25 mm | 111 | 104 | 99 | 100 | 108 | 67 | 93 | 127 | 101 |
| Tropical Seals A/B | 100° C. g/25 mm | 47 | 9 | 10 | 13 | 21 | 10 | 12 | 11 | 17 |
| Hot Tack | Grams | 150 | 150 | 150 | 150 | 150 | 150 | 150 | 150 | 150 |
| H S J R | 110° C. | 73 | 73 | 96 | 80 | 72 | 73 | 68 | 85 | 78 |
| g/25 mm | 130° C. | 34 | 33 | 39 | 34 | 46 | 38 | 28 | 35 | 36 |
| | 150° C. | 12 | 11 | 10 | 11 | 12 | 11 | 9 | 12 | 11 |
| P Block | ?/30 | 20 | 17 | 24 | 21 | 23 | 30 | 30 | 30 | 24 |
| C O F | A-A | 0.4033 | 0.3921 | 0.3902 | 0.3896 | 0.3598 | 0.3754 | 0.3666 | 0.3624 | 0.38 |
| | A-B | 0.3752 | 0.3736 | 0.3723 | 0.3743 | 0.3764 | 0.3843 | 0.3728 | 0.3699 | 0.37 |
| | B-B | 0.3881 | 0.3965 | 0.3909 | 0.3771 | 0.3810 | 0.3732 | 0.3770 | 0.3576 | 0.38 |
| Sauressig print* | | | 9/8 | 7/5 | 7/4 | | 9/9 | | | |

WVP* Measured under temperate conditions

### Example 2

### Extrusion PLA Coating for Cellulose Film

Extrusion coating was tested as a potential alternative coating route for cellulose products. In this coating process, a thin film of molten polymer is extruded through a flat die and pressed onto the cellulose substrate. Pressure is applied between the nip roll and the driven water-cooled chill roll. Advantages of this process over solvent-based coatings are the absence of hazardous substances and the need for a recovery system, the melting process which bioplastics are primarily designed to compared with solvents mixtures and the higher coat gain.

In atrial run, two biodegradable resins: PLA-based resin (modified-PLA) Danimer 26806 and synthetic copolyester Ecoflex SBX 7025 were tested. Other potential candidates are: PHB-based resin Biomer P209, Starch-based Mater-bi grade from Novamont, and Starch-based resin Cohpol from VTT. The cellulose base used in the trial was a 575 monoweb with EE softeners and MF anchor agent. Dimensions of the reels were 500 mm in width and 570 mm in OD. Thick base has been chosen to withstand tension during coating process. No film breaking has been observed during the trial, with the machine running between 50 and 100 m/min (limit of the machine 350 no/min but industrial machine for paper coating typically running around 100 m/min).

The settings for the process/machine are listed in Table 4. The physical properties of the coated films are shown in Table 5.

TABLE 4

| | | |
|---|---|---|
| Parameters | Bottom limit | Top limit |

| | |
|---|---|
| Temperature profile | Follow supplier's recommendation |

| | | | |
|---|---|---|---|
| Speed of line | 50 m/min | 350 | m/min |
| Corona treatment | 0 | 3.8 | kW |

| | |
|---|---|
| Chill roll temperature | Follow supplier's recommendation |
| Die height (air gap) | Follow supplier's recommendation |
| Point of contact of molten | Adjustable |
| curtain on the web | |
| Pressure of nip roll | Fixed at max 6.5 bars |

TABLE 5

| Resin | Danimer | Danimer | Danimer | Danimer | Danimer | Danimer | Danimer | Danimer |
|---|---|---|---|---|---|---|---|---|
| Base reel | 1 | 1 | 2 | 2 | 2 | 2 | 2 | 2 |
| Corona | 0 | 2 | 2 | 2 | 2 | 2 | 3 | 3.8 |
| Line speed | 50 | 50 | 50 | 60 | 70 | 80 | 50 | 80 |
| Temperature profile | − | − | − | − | − | − | + | + |
| Chill roll temperature | 20 | 17 | 17 | 17 | 21 | 22 | 25 | 24 |
| Pressure of nip rolls (bars) | 6.5 | 6.5 | 6.5 | 6.5 | 6.5 | 6.5 | 6.5 | 6.5 |
| Thickness (μ) | n/a | n/a | 57 | 55 | 52 | 50 | 55 | 52 |
| Coat gain (gsm) | 21 | 20 | 18 | 13 | 13 | 11 | 17 | 14 |
| WAH (%) | 32.1 | n/a | 32.9 | 29.7 | 28.7 | 30.1 | 36.1 | 35.3 |
| Adhesion (g/25 mm) | | | 54 | | | | | |
| Seals 100° C. (g/25 mm)* | 599 | n/a | 878 | 750 | 656 | 773 | 981 | 848 |
| Seals135° C. (g/25 mm)* | 1355 | n/a | 969 | 906 | 936 | 799 | 1052 | 848 |
| Hot tack | | | 150 | | | | | |
| Seals to PLA | Weld | n/a | Weld | Weld | Weld | Weld | Weld | Weld |
| | seal | | seal | seal | seal | seal | seal | seal |
| Dry seals** | n/a | n/a | 1388 | | | | | |
| Wet seals—tap water** | n/a | n/a | 892 | | | | | |
| Wet seals—boiling water** | n/a | n/a | 1154 | | | | | |
| WVP—25° C. 75RH—24 h | n/a | n/a | 177 | | | | | |
| Tear resistance MD (%) | n/a | n/a | 4.1 | 3.3 | 3.5 | 3.5 | 3.6 | 3.8 |
| Tear resistance TD (%) | n/a | n/a | 2.6 | 2.6 | 2.6 | 2.7 | 2.5 | 2.6 |
| Stiffness MD | n/a | n/a | 128 | | | | | |

| | | | | | | Cello | |
|---|---|---|---|---|---|---|---|
| Resin | Danimer | Danimer | Ecoflex | Ecoflex | Ecoflex | base | DNE |
| Base reel | 2 | 2 | 2 | 2 | 2 | | |
| Corona | 3.8 | 3.8 | 0 | 3.8 | 3.8 | | |
| Line speed | 80 | 100 | 50 | 50 | 80 | | |
| Temperature profile | − | − | n/a | n/a | n/a | | |
| Chill roll temperature | 29 | 29 | 22 | 22 | 22 | | |
| Pressure of nip rolls (bars) | 6.5 | 6.5 | 6.5 | 6.5 | 6.5 | | |
| Thickness (μ) | 47 | 47 | 48 | 47 | 45 | 38 | 18 |
| Coat gain (gsm) | 10 | 9 | 16 | 11 | 7 | 0 | 1 |
| WAH (%) | 25.9 | 27.2 | 10.2 | 9.4 | 11.7 | 3.1 | |
| Adhesion (g/25 mm) | | 72 | 395 | 275 | 405 | | |
| Seals 100° C. (g/25 mm)* | 728 | 693 | 1005 | 1470 | 749 | | |
| Seals135° C. (g/25 mm)* | 802 | 723 | 1519 | 1479 | 1389 | | |
| Hot tack | | 150 | 150 | | 150 | | |
| Seals to PLA | Weld | Weld | Weld | Weld | Weld | | |
| | seal | seal | seal | seal | seal | | |
| Dry seals** | | 641 | 543 | | 264 | | 384 |
| Wet seals—tap water** | | 635 | 464 | | 226 | | |
| Wet seals—boiling water** | | 564 | 409 | | 287 | | 36 |
| WVP—25° C. 75RH—24 h | | 201 | 245 | | 109 | | |
| Tear resistance MD (%) | 3.3 | 4.0 | 3.4 | 3.0 | 2.6 | 3.1 | 3.1 |
| Tear resistance TD (%) | 2.5 | 2.9 | 2.6 | 2.3 | 2.2 | 2.7 | 2.7 |
| Stiffness MD | | 91 | 85 | | 89 | 68 | 68 |

*0.5 s, 10 psi
**150° C., 0.2 s, 40 psi, 1 min in water when specified

### Example 3

### Comparison of Film Mechanical Properties

Comparison of thermal and mechanical properties was made using a cellulose NatureFlex film coated on both sides with a biodegradable, printable or otherwise functional coating or skin layer (CELLULOSE), a 50 micron thick PLA film comprising a three layer PLA film with heat sealable coextruded layers on the outside (PLA) and a 50 micron thick bi-axially oriented polypropylene (BOPP) film made by the bubble process (BOPP).

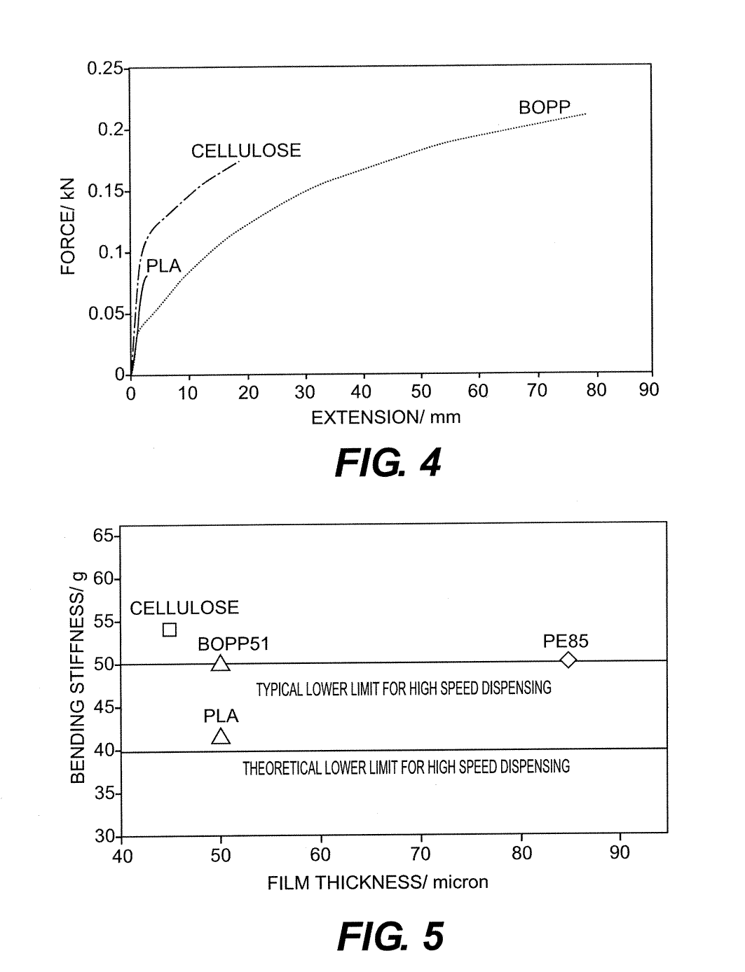

FIG. 4 shows the force-extension curves for Sample 9, PLA and BOPP measured in tension using a tensometer. A high initial slope in the curve indicates a high modulus and a large extension means that the film can be stretched a long way prior to breaking. FIG. 4 clearly shows that both CELLULOSE and PLA are stiffer than a 50 micron BOPP, with the relative stiffness being in the order CELLULOSE>PLA>BOPP. BOPP is known to dispense efficiently, thus it is envisaged that both CELLULOSE and PLA would dispense easily.

From the tensile force-extension curve it can also be seen that PLA is relatively brittle compared to the other films, having only a very low extension at break. CELLULOSE allows for some extensibility prior to breaking (up to 20 mm) whilst BOPP has a high extension to break. The two new materials therefore have a higher resistance to deformation than BOPP which is a good indication of ease of conversion during adhesive lamination.

The theoretical dispensing performance of a film can be further highlighted by measuring bending stiffness. While not directly related to the tensile modulus given by a stress-strain curve, bending stiffness is arguably a better measure of the ability of a film to dispense. The bending stiffness of the CELLULOSE, PLA, BOPP and a 85 micron thick PE film were measured using a handle-ometer. FIG. 5 shows that the relative stiffness is in the order of CELLULOSE>BOPP (=PE 85)>PLA and that both CELLULOSE and PLA have above the recognised lower limit of bending stiffness for high speed dispensing.

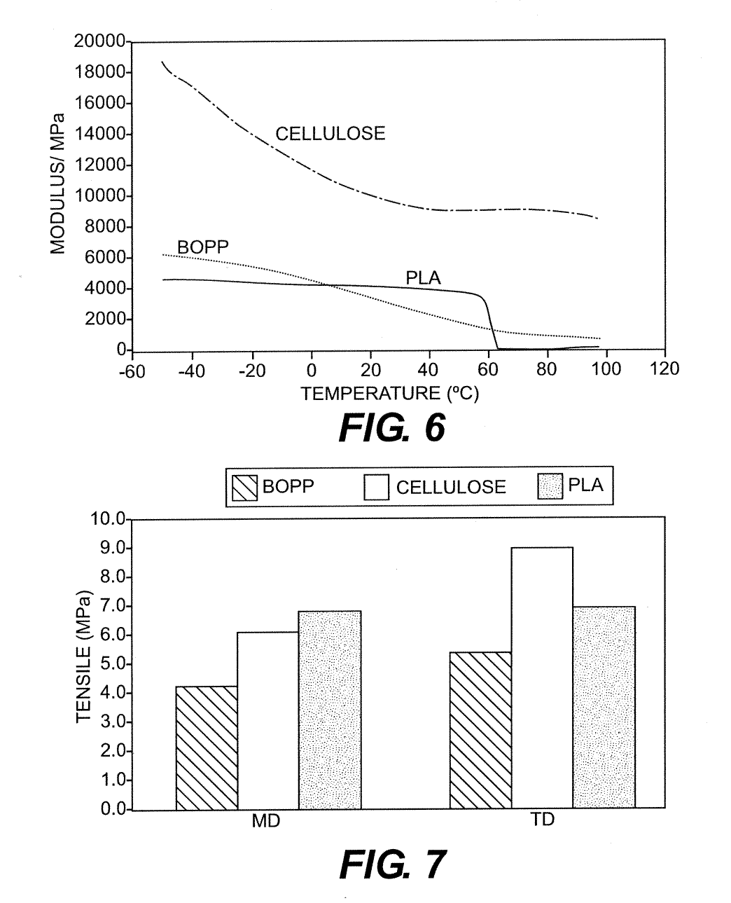

Another important factor to consider is the response of a film when subjected to heat, particularly as the film will need to withstand the often elevated temperatures experienced during printing, through drying ovens or heat emitted by UV curing lamps. Dynamic mechanical thermal analysis is often used to study how a film's modulus (stiffness) changes with temperature. FIG. 6 shows tensile DMTA scans for CELLULOSE, PLA and BOPP, from −50° C. to +100° C. All three films show a gradual decrease in modulus with increasing temperature, with very high moduli being shown at sub-zero temperatures. As the temperature increases in the range 20° C. to 100° C., dramatic differences can be observed in the moduli of the three films. CELLULOSE gives virtually flat performance in this range, whilst BOPP continues to show a gradual lowering of its modulus as the classical softening behaviour of a polyolefin is observed in this range. PLA, however shows a dramatic loss of modulus at 60° C. which can be attributed to the glass transition temperature of the material (T_{g}). T_{g} is associated with the enabling of large scale molecular rotation and movement where the polymers chains effectively come out of their locked-in or “frozen” state and the polymer exhibits a transition from glassy to rubbery behaviour. The data shows that CELLULOSE is very stable at the typical temperature that might be observed in a printing press. BOPP shows lower thermal stability and care would need to be taken not to allow PLA to approach such temperatures in case of potential print registration issues.

One area where BOPP has shown to have excellent performance is in die-cutting. As opposed to paper, oriented polypropylenes show high resistance to tearing, thus enabling labels with high quality edge appearance after punch die-cutting. The tear initiation resistance of the three films is shown in FIG. 7. Clearly both CELLULOSE and PLA have significantly higher tear resistance than BOPP, thus their die-cutting performance might be expected to be similar if not even better than a typical BOPP.

In another experiment, the thermal and mechanical properties of BOPP film and cellulose films (Sample 9 and Sample 10) and a polylactic acid (PLA) film were compared (Table 6). The mechanical and thermal properties of the films are shown in Tables 7 and 8.

TABLE 6
Sample details

| Test | | | | |
|---|---|---|---|---|
| Samples | | Thickness | | Sample |
| No. | Source | (microns) | Structure | Description |
| 001 | Plastic | 40 | 3 Layer | Earthfirst |
| | Suppliers/ | | coextruded, melt | PLA 40 |
| | Sidaplax | | blown PLA | |
| 002 | Innovia Films | 51 | 5 layer coextruded, | BOPP |
| | | | biaxially oriented | (CPA51) |
| | | | PP with print | |
| | | | receptive coating | |
| | | | layer | |
| 003 | Innovia Films | 45 | 2 side coated | Sample 9 |
| | | | cellulose film | |
| 004 | Innovia FIlms | 45 | 2 side coated | Sample 10 |
| | | | cellulose film | |

Sample 9 = Natureflex ™ NVL,
Sample 10 = White Natureflex ™

TABLE 7
Machine Direction (MD) Tensile Properties

| Tensile | Strain Rate | Sample No. | | | |
|---|---|---|---|---|---|
| Property | (%/min) | 001 | 002 | 003 | 004 |
| Elongation | 50 | 3 | 92 | 21 | 17 |
| at Break | 100 | 2 | 90 | 19 | 16 |
| (%) | 200 | 3 | 86 | 23 | 17 |
| Tensile | 50 | 67.0 | 176 | 177 | 178 |
| Strength | 100 | 61.8 | 181 | 148 | 163 |
| (MPa) | 200 | 63.3 | 170 | 167 | 164 |
| Young's | 50 | 3780 | 2290 | 7410 | 7930 |
| Modulus | 100 | 3400 | 2420 | 6760 | 7400 |
| (MPa) | 200 | 3380 | 2380 | 7200 | 7220 |
| 1% Secant | 50 | 3410 | 2260 | 6920 | 7420 |
| Modulus | 100 | 2840 | 2380 | 6390 | 6940 |
| (Mpa) | 200 | 2460 | 2340 | 6730 | 6870 |
| Load At | 50 | 80.4 | 224.8 | 182.8 | 179.1 |
| Break (N) | 100 | 83.5 | 226.8 | 181.0 | 183.9 |
| | 200 | 85.5 | 225.9 | 195.9 | 189.0 |

TABLE 8
Transverse Direction (TD) Tensile Properties

| Tensile | Strain Rate | Sample No. | | | |
|---|---|---|---|---|---|
| Property | (%/min) | 001 | 002 | 003 | 004 |
| Elongation | 50 | 3 | 109 | 61 | 55 |
| at Break | 100 | 3 | 107 | 57 | 58 |
| (%) | 200 | 3 | 104 | 61 | 56 |
| Tensile | 50 | 78.8 | 169 | 89.8 | 86.1 |
| Strength | 100 | 66.6 | 172 | 86.4 | 79.5 |
| (MPa) | 200 | 66.4 | 164 | 97.0 | 85.1 |
| Young's | 50 | 4410 | 2450 | 4120 | 4400 |
| Modulus | 100 | 3560 | 2420 | 3860 | 3920 |
| (MPa) | 200 | 3420 | 2360 | 4370 | 4170 |
| 1% Secant | 50 | 4080 | 2320 | 3820 | 4030 |
| Modulus | 100 | 3010 | 2330 | 3570 | 3590 |
| (Mpa) | 200 | 2640 | 2270 | 4080 | 3870 |
| Load At | 50 | 82.7 | 215.4 | 94.3 | 88.3 |
| Break (N) | 100 | 84.9 | 214.7 | 105.8 | 93.4 |
| | 200 | 85.6 | 216.7 | 111.6 | 95.7 |

A frequency sweep was carried out at 25° C. on a Dynamic Mechanical Analyser (DMA). The modulus or “stiffness” increases at increasing frequencies for all film types in the test range of 0.01 to 80 Hz. Following the frequency sweep, a temperature sweep at fixed frequency (3 Hz) was carried out. For the PLA and BOPP films (samples 001 and 002), the loss modulus (and tan delta-tan delta is the ratio of loss modulus to storage modulus) exhibited a peak at temperatures corresponding to the glass transition temperatures of the respective polymers. For PLA film, the peak temperature was slightly higher for the TD sample than for the MD sample possibly due to orientation factors. Neither cellulose film exhibited this behavior. They, if anything, tended to exhibit a minimum rather than a peak.

Thermogravimetric Analysis (TGA) revealed a single weight loss event for both PLA and BOPP films when heated under nitrogen. The weight loss profile of the cellulose films was more complex than that of PLA or BOPP. The PLA film completely degraded at a lower temperature than BOPP film. The weight losses observed in the cellulose films correspond to loss of softener followed by carbonization of the cellulose (loss of water to leave the carbon skeleton behind) and finally conversion of the carbonized cellulose to carbon dioxide after the admission of air at 750° C. The residue relates to the titanium dioxide (TiO₂) for the white films (samples 001 and 004).

Differential scanning calorimetry (DSC) reveals the thermal transitions that occur within the various films. PLA (sample 001) exhibits a glass transition (Tg) at about 60° C. followed by “cold” crystallization and crystalline perfection prior to melting (Tm) at above 165° C. BOPP exhibits only a Tm above 160° C. and cellulose films exhibit no thermal transitions though the initial heat run contains evidence that softener is lost at elevated temperatures.

When thermal transitions (Tg and Tm) occur, there are accompanying dramatic changes in other properties of the film, including changes in volume and changes in mechanical properties. These changes will be observed as either dramatic expansion or shrinkage of the film with an accompanying dramatic change in the stiffness (modulus) and tensile strength of the film. Elongation to break might also alter dramatically in passing through a transition temperature. Loss of softener (as in the case of the cellulose films) has a less dramatic effect, though can be expected to make the film more brittle.

In summary, the experimental data showed that cellulose films have a higher modulus and hence are stiffer than either BOPP or PLA films allowing lower gauge films to be used in any given application. Cellulose films do not undergo any thermal transitions therefore there are no dramatic property changes observed over a wide temperature range.

### Example 4

### UV Printing Capabilities of Biodegradable Film

Samples of a cellulose label film (Sample 11), CPA51 and CA51 have been tested in order to determine the UV printing capabilities of the cellulose label film against BOPP label film CPA51 and CA51 (Table 9). Both UV Screen and UV Flexo printing were carried out using an Adelco screen printer with standard screen mesh 120 and the R. K Proofer flexo hand roller. The printing results are shown in Tables 10 and 11.

TABLE 9
Sample details

| Test Samples No. | Sample Type | Sample Description |
|---|---|---|
| 001 | Film | Sample 11 (Sp. 11) |
| 002 | Film | BOPP (CPA51) |
| 003 | Film | BOPP (CA51) |

Sample 11 = Natureflex 45E946

TABLE 10
UV Flexo Printing

| | | | | % | | |
|---|---|---|---|---|---|---|
| | | | | Ink | | |
| Film | Ink | | Curing | Pull | Coin | |
| Type | Colour | Supplier | Conditions | Off | Scratch | X-Hatch |
| Sp. 11 | White | Sericol | 125 W/1 pass | 40 | Poor | Poor |
| | | | 125 W/2 pass | 0 | Poor | Poor |
| | | | 200 W/1 pass | 0 | Poor | Good |
| | | | 200 W/2 pass | 0 | Poor | Good |
| | | | 300 W/1 pass | 0 | Marring | Good |
| | | | 300 W/2 pass | 0 | Good | Good |
| Sp. 11 | Orange | Sericol | 125 W/1 pass | 90 | Poor | Poor |
| | | | 125 W/2 pass | 70 | Poor | Good |
| | | | 200 W/1 pass | 40 | Marring | Good |
| | | | 200 W/2 pass | 5 | Good | Borderline |
| | | | 300 W/1 pass | 0 | Good | Borderline |
| | | | 300 W/2 pass | 0 | Good | Good |
| CPA51 | White | Sericol | 125 W/1 pass | *50 | Poor | Poor |
| | | | 125 W/2 pass | *20 | Poor | Poor |
| | | | 200 W/1 pass | 0 | Marring | Good |
| | | | 200 W/2 pass | 0 | Marring | Good |
| | | | 300 W/1 pass | 0 | Good | Good |
| | | | 300 W/2 pass | 0 | Good | Good |
| CPA51 | Orange | Sericol | 125 W/1 pass | *50 | Poor | Poor |
| | | | 125 W/2 pass | *20 | Poor | Poor |
| | | | 200 W/1 pass | 0 | Marring | Good |
| | | | 200 W/2 pass | 0 | Marring | Good |
| | | | 300 W/1 pass | 0 | Good | Good |
| | | | 300 W/2 pass | 0 | Good | Good |
| CA51 | White | Sericol | 125 W/1 pass | 0 | Poor | Poor |
| | | | 125 W/2 pass | 0 | Poor | Good |
| | | | 200 W/1 pass | 0 | Marring | Borderline |
| | | | 200 W/2 pass | 0 | Marring | Good |
| | | | 300 W/1 pass | 0 | Good | Good |
| | | | 300 W/2 pass | 0 | Good | Good |
| CA51 | White | Sericol | 125 W/1 pass | 0 | Poor | Good |
| | | | 125 W/2 pass | 20 | Poor | Good |
| | | | 200 W/1 pass | 10 | Marring | Poor |
| | | | 200 W/2 pass | 0 | Good | Good |
| | | | 300 W/1 pass | 0 | Good | Good |
| | | | 300 W/2 pass | 0 | Good | |

Conditions: 40 (feet per inch)
*Top surface of ink lifted.

TABLE 11
UV Screen Printing
UV Screen Printing

| | | | | % | | |
|---|---|---|---|---|---|---|
| | | | | Ink | | |
| Film | Ink | | Curing | Pull | Coin | |
| Type | Colour | Supplier | Conditions | Off | Scratch | X-Hatch |
| Sp. 11 | White | Sericol | 125 W/1 pass | 0 | Poor | Borderline |
| | | | 125 W/2 pass | 0 | Poor | Borderline |
| | | | 200 W/1 pass | 0 | Marring | Good |
| | | | 200 W/2 pass | 0 | Good | Good |
| | | | 300 W/1 pass | 0 | Marring | Good |
| | | | 300 W/2 pass | 0 | Good | Good |
| Sp. 11 | Orange | Sericol | 125 W/1 pass | 40 | Poor | Poor |
| | | | 125 W/2 pass | 30 | Marring | Poor |
| | | | 200 W/1 pass | 20 | Poor | Poor |
| | | | 200 W/2 pass | 0 | Good | Good |
| | | | 300 W/1 pass | 0 | Good | Good |
| | | | 300 W/2 pass | 0 | Good | Good |
| CPA51 | White | Sericol | 125 W/1 pass | 10 | Poor | Poor |
| | | | 125 W/2 pass | 0 | Poor | Poor |
| | | | 200 W/1 pass | 0 | Good | Good |
| | | | 200 W/2 pass | 0 | Good | Good |
| | | | 300 W/1 pass | 0 | Good | Good |
| | | | 300 W/2 pass | 0 | Good | Good |
| CPA51 | Orange | Sericol | 125 W/1 pass | not | Poor | Poor |
| | | | | dry | | |
| | | | 125 W/2 pass | not | Poor | Poor |
| | | | | dry | | |
| | | | 200 W/1 pass | 30 | Poor | Poor |
| | | | 200 W/2 pass | 0 | Good | Good |
| | | | 300 W/1 pass | 10 | Good | Good |
| | | | 300 W/2 pass | 0 | Good | Good |
| CA51 | White | Sericol | 125 W/1 pass | not | Poor | Poor |
| | | | | dry | | |
| | | | 125 W/2 pass | 0 | Poor | Borderline |
| | | | 200 W/1 pass | 0 | Marring | Good |
| | | | 200 W/2 pass | 0 | Good | Good |
| | | | 300 W/1 pass | 0 | Good | Good |
| | | | 300 W/2 pass | 0 | Good | Good |
| CA51 | White | Sericol | 125 W/1 pass | 20 | Poor | Poor |
| | | | 125 W/2 pass | 0 | Poor | Poor |
| | | | 200 W/1 pass | 0 | Poor | Poor |
| | | | 200 W/2 pass | 0 | Good | Good |
| | | | 300 W/1 pass | 0 | Good | Good |
| | | | 300 W/2 pass | 0 | Good | Good |

Conditions: Standard 120 Mesh Screen
Not dry: The ink still wet

As shown in Tables 10 and 11, with the curer set at 300 watts all three films exhibited good adhesion, scratch and X-hatch, the films exhibited slight marring of the surface in some cases. Reducing the curer to 200 watts did not significantly affect the ink adhesion, but had a slightly negative effect on scratch and X-hatch. At 125 watts adhesion, scratch and x-hatch were compromised, in some cases the curer failed to dry the wet ink. These data show that the cellulose film performed well when printed with both UV techniques. Ink adhesion, scratch and x-hatch on the cellulose films were as good as those on BOPP films.

### Example 5

### Shrinkage Properties of Biodegradable Film

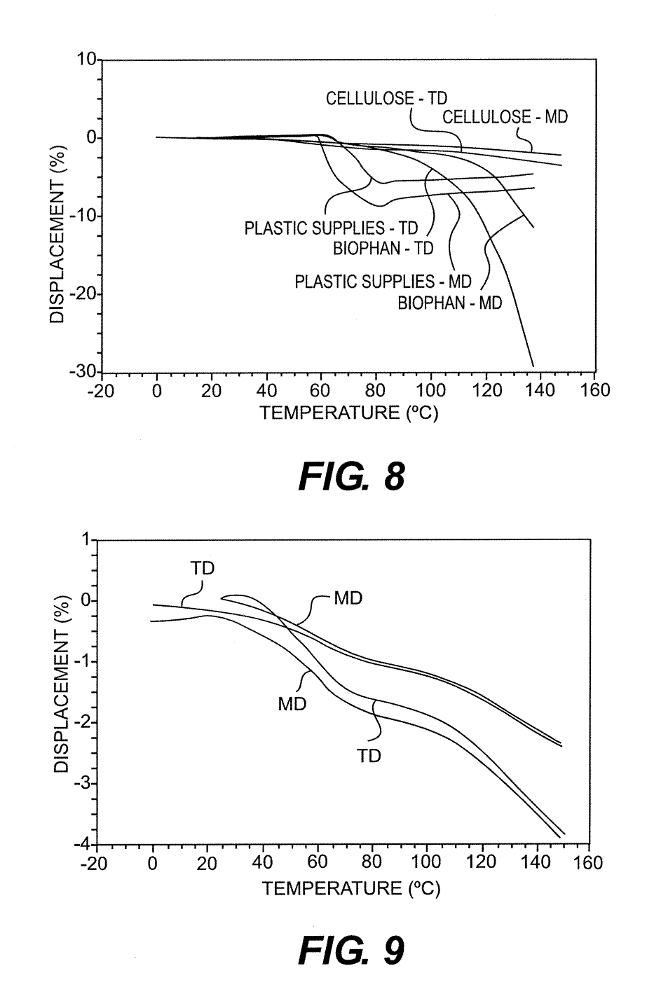

Thermomechanical analysis (TMA) was carried out using a sample of cellulose film (CELLULOSE). The results were compared against historical data on a PLA film from Plastic Supplies (PLASTIC SUPPLIES) and a PLA film from Biophan (BIOPHAN). Briefly, a strip was cut from the cellulose film in the machine direction and loaded into the DMA, set to a constant force of 0.001N. After measuring the length, the film as heated at 2° C. and the resulting dimension change recorded. Repeating for a strip cut in the transverse direction allows any orientation effects to be seen. FIG. 8 shows the shrinkage curves of the cellulose film, as well as the shrinkage curves of PLA films from Plastic Supplies and Biophan, obtained in an earlier test. FIG. 9 shows the effects of pre-cooling the cellulose film to 0° C. The data show that the cellulose film exhibits greater dimensional stability than the PLA films at temperatures higher than the glass transition temperature of the PLA films. However, the loss of volatile compounds from the cellulose results in higher levels of shrinkage at temperatures below the glass transition temperature of the PLA films.

The above description is for the purpose of teaching the person of ordinary skill in the art how to practice the present invention, and it is not intended to detail all those obvious modifications and variations of it which will become apparent to the skilled worker upon reading the description. It is intended, however, that all such obvious modifications and variations be included within the scope of the present invention, which is defined by the following claims. The claims are intended to cover the components and steps in any sequence which is effective to meet the objectives there intended, unless the context specifically indicates the contrary.

What is claimed is:

1. A biodegradable, printable or otherwise functional, multi-layer film comprising
a biodegradable core layer; and
a biodegradable, printable or otherwise functional skin layer of a different material from that of the biodegradable core layer on at least one side of the film,
wherein at least one of the biodegradable core layer and the biodegradable skin layer comprising a biopolymer.

2. The multi-layer film of claim 1, wherein the biodegradable core layer is selected from the group consisting of biodegradable polymers, paper, post consumer reclaim (PCR) fibres, and biodegradable polyethylene.

3. The multi-layer film of claim 2, wherein the biodegradable polymers are obtained or obtainable from a biological source.

4. The multi-layer film of claim 3, wherein the biological source is a plant or microbial source.

5. The multi-layer film of claim 2, wherein the biodegradable polymers are selected from the group consisting of carbohydrates, polysaccharides, gums, proteins, colloids, polyorganic acids and polyesters, effective mixtures thereof, and effective modified derivatives thereof.

6. The multi-layer film of claim 5, wherein the polysaccharides are selected from the group consisting of cellulose, starch, glycogen, hemi-cellulose, chitin, fructan, inulin, lignin and pectic substances.

7. The multi-layer film of claim 5, wherein the proteins are selected from the group consisting of cereal, vegetable and animal proteins.

8. The multi-layer film of claim 7, wherein the proteins are selected from the group consisting of gluten, whey protein and gelatin.

9. The multi-layer film of claim 5, wherein the polyorganic acids and esters are selected from the group consisting of polylactic acid (PLA), polygalactic acid (PGA), polyhydroxy-alkanoate (PHA), polyhydroxy butyrate (PHB), polycaprolactone) (PCL), poly-methyl 4-hydroxybenzoate (MHB) and polyhydroxy-benzonate (PHB).

10. The multi-layer film of claim 1, wherein the biodegradable, printable or otherwise functional skin layer is selected from the group consisting of biodegradable polymers, paper, post consumer reclaim (PCR) fibres, and biodegradable polyethylene.

11. The multi-layer film of claim 10, wherein the biodegradable polymers are obtained or obtainable from a biological source.

12. The multi-layer film of claim 11, wherein the biological source is a plant or microbial source.

13. The multi-layer film of claim 11, wherein the biodegradable polymers are selected from the group consisting of carbohydrates, polysaccharides, gums, proteins, colloids, polyorganic acids and polyesters, effective mixtures thereof and effective modified derivatives thereof.

14. The multi-layer film of claim 13, wherein the polysaccharides are selected from the group consisting of cellulose, starch, glycogen, hemi-cellulose, chitin, fructan, inulin, lignin and pectic substances.

15. The multi-layer film of claim 13, wherein the proteins are selected from the group consisting of cereal, vegetable and animal proteins.

16. The multi-layer film of claim 15, wherein the proteins are selected from the group consisting of gluten, whey protein and gelatin.

17. The multi-layer film of claim 13, wherein the polyorganic acids and esters are selected from the group consisting of polylactic acid (PLA), polygalactic acid (PGA), polyhydroxy-alkanoate (PHA), polyhydroxy butyrate (PHB), polycaprolactone) (PCL), poly-methyl 4-hydroxybenzoate (MHB) and polyhydroxy-benzonate (PHB).

18. The multi-layer film of claim 1, wherein at least one of the core layer, the skin layer, and a further layer of the film is a cellulosic layer.

19. The multi-layer film of claim 1, wherein at least one of the core layer, the skin layer, and a further layer of the film is paper.

20. The multilayer film of claim 1, wherein at least one of the core layer, the skin layer, and a further layer of the film is a biodegradable polyester.

21. The multi-layer film of claim 1, further comprising a primer layer between said core layer and said printable or otherwise functional layer.

22. The multi-layer film of claim 1, further comprising a biodegradable, sealable coating layer.

23. The multi-layer film of claim 22, wherein said sealable layer covers said printable or otherwise functional layer.

24. The multi-layer film of claim 22, wherein said printable or otherwise functional layer and said sealable layer are located on the opposite side of said core layer.

25. The multi-layer film of claim 1, further comprising a second biodegradable printable or otherwise functional layer, wherein said first and second biodegradable printable or otherwise functional layers are located on the opposite sides of said core layer.

26. The multi-layer film of claim 1, further comprising a pressure sensitive adhesive layer, wherein said pressure sensitive adhesive layer and said first biodegradable printable or otherwise functional layer are located on the opposite sides of said core layer.

27. The multi-layer film of claim 26, wherein said pressure sensitive adhesive layer is covered with a release layer.

28. The multi-layer film of claim 1, further comprising a barrier layer.

29. The multi-layer film of claim 11, wherein said barrier layer is a metal layer.

30. The multi-layer film of claim 1, wherein the biopolymer is selected from the group consisting of carbohydrates, polysaccharides, gums, proteins, colloids, polyorganic acids and polyesters, effective mixtures thereof and effective modified derivatives thereof.

31. The multi-layer film of claim 30, wherein the polysaccharides are selected from the group consisting of cellulose, starch, glycogen, hemi-cellulose, chitin, fructan, inulin, lignin and pectic substances.

32. The multi-layer film of claim 30, wherein the proteins are selected from the group consisting of cereal, vegetable and animal proteins.

33. The multi-layer film of claim 32, wherein the proteins are selected from the group consisting of gluten, whey protein and gelatin.

34. The multi-layer film of claim 30, wherein the polyorganic acids and esters are selected from the group consisting of polylactic acid (PLA), polygalactic acid (PGA), polyhydroxy-alkanoate (PHA), polyhydroxy butyrate (PHB), polycaprolactone) (PCL), poly-methyl 4-hydroxybenzoate (MHB) and polyhydroxy-benzonate (PHB).

35. The multi-layer film of claim 1, further comprising biodegradable ink layer.
